(19) United States
(12) Patent Application Publication
(10) Pub. No.: US 2013/0310473 A1
(43) Pub. Date: Nov. 21, 2013

(54) DINT IN EXPANDED PVC PASTES

(71) Applicants: Hinnerk Gordon Becker, Essen (DE); Michael Grass, Haltern am See (DE)

(72) Inventors: Hinnerk Gordon Becker, Essen (DE); Michael Grass, Haltern am See (DE)

(73) Assignee: Evonik Oxeno GmbH, Marl (DE)

(21) Appl. No.: 13/989,421

(22) PCT Filed: Oct. 28, 2011
(86) PCT No.: PCT/EP11/69039

§ 371 Date: Aug. 7, 2013

(30) Foreign Application Priority Data
Nov. 24, 2010 (DE) 10 2010 061 869.1

(51) Int. Cl. C08K 5/12

(52) U.S. Cl. CPC C08K 5/12
USPC 521/97

(57) ABSTRACT

The invention relates to a foamable composition containing at least one polymer selected from the group consisting of polyvinyl chloride, polyvinylidene chloride, polyvinyl butyrate, polyalkyl methacrylate and copolymers thereof, a foam former and/or foam stabilizer and diisononyl terephthalate as plasticizer, wherein the average degree of branching of the isononyl groups in the ester is in the range from 1.15 to 2.5.

The invention further relates to foamed mouldings and to the use of the foamable composition for floor coverings, wall coverings or artificial leather.

The invention relates to a foamable composition containing at least one polymer selected in particular from the group consisting of polyvinyl chloride, polyvinylidene chloride, polyvinyl butyrate, polyalkyl methacrylate and copolymers thereof, a foam former and/or foam stabilizer and diisononyl terephthalate as plasticizer.

Polyvinyl chloride (PVC) is one of the most important polymers in economic terms. It is used in a wide variety of applications, in the form of plasticized PVC as well as unplasticized PVC. Examples of important application sectors are cable sheathing, floor coverings, wall coverings and also frames for plastics windows. Plasticizers are added to the PVC in order to increase flexibility. These customary plasticizers include for example phthalic esters such as di-2-ethylhexyl phthalate (DEHP), diisononyl phthalate (DINP) and diisodecyl phthalate (DIDP). Recent additions to the range of available plasticizers are cyclohexane dicarboxylic esters such as diisononyl cyclohexanecarboxylate (DINCH) for example.

Many PVC articles are typically made to include layers of foam in order that the weight of the products and thus also the costs may be reduced by virtue of the lower material requirements. The user of a foamed product can benefit from superior structureborne sound insulation in the case of floor coverings for example.

The quality of foaming depends on many components within the formulation in that the type of PVC used and the plasticizer play an important part as well as the type and amount of foam former used. Good foaming is known to be achievable when the formulation recipe includes at least a proportion of fast-gelling plasticizers (known as fast-gellers) especially.

It is known that as the chain length of the esters increases the dissolving/gelling temperatures and thus the processing temperatures of the plasticized PVC rise. A possible consequence of this is that the high temperatures cause the PVC to discolour, which is undesirable in most applications. Fast-gellers are added to lower the processing temperatures. They also include isononyl benzoate for example. However, the high solvation power of fast-gellers has the disadvantage of leading over time (including in the course of storage at room temperature) to a marked increase in the viscosity of plastisols, and so viscosity-reducing agents have to be added in turn to compensate this effect. These measures are cost intensive and make the processing operation expensive. It is also known that the processing rate in many moulding processes for polymer plastisols/polymer pastes, especially for PVC plastisols/PVC pastes, depends on the plastisol viscosity in particular in that a low plastisol viscosity allows higher processing rates and hence improves the economics of the manufacturing operation.

A requirement in the production of PVC plastisols is therefore that a very low viscosity and a low gelling temperature is maintained during processing. Another requirement is a high storage stability for the PVC plastisol.

Hitherto there are scarcely any plasticizers that both lower the gelling temperatures of a formulation significantly and keep the viscosity of the plastisol at a low level even after a storage period of several days.

EP 1 505 104 describes a foamable composition containing isononyl benzoate as plasticizer. The use of isononyl benzoates as plasticizer, however, has the appreciable disadvantage that isononyl benzoates are very volatile and therefore escape from the polymer during processing and also with increasing storage and service time. This presents appreciable problems with applications in interiors in particular for example. Therefore, isononyl benzoates are frequently used in the prior art as plasticizer admixtures with customary other plasticizers such as phthalic esters for example. Isononyl benzoates are also used as fast-gellers, the term fast-geller being used for plasticizers which provide a comparatively (versus diisononyl terephthalate for example) faster gelling and/or a gelling at lower temperatures.

Further prior art plasticizers for use in PVC include alkyl terephthalates. EP 1 808 457 A1 describes the use of dialkyl terephthalates characterized in that the alkyl radicals have a longest carbon chain of four or more carbon atoms and five carbon atoms per alkyl radical in total. Terephthalic esters having four to five carbon atoms in the longest carbon chain of the alcohol are said to be very useful as fast-gelling plasticizers for PVC. This is also said to be surprising particularly because theretofore such terephthalic esters were regarded in the prior art as incompatible with PVC.

The reference in question further states that dialkyl terephthalates are also useful in chemically or mechanically foamed layers or in compact layers/primers.

WO 2009/095126 A1 describes mixtures of diisononyl esters of terephthalic acid and also processes for production thereof. These diisononyl terephthalate mixtures are characterized by a certain average degree of branching for the isononyl radicals, which is in the range from 1.0 to 2.2. The compounds are used as plasticizers for PVC.

It is a further disadvantage of the prior art plasticizers that when used in foamable compositions, it is frequently the case that the compositions foam to inadequate foam heights. To obtain adequate foam heights it is then necessary to employ higher temperatures, but this at the same time causes an increase in the yellowness index and hence an undesirable discoloration of the PVC foam. Alternatively, the amount of blowing agent in the recipe/formulation can also be increased for this purpose, although this greatly adds to the cost of the recipe/formulation.

The technical problem addressed by the invention is therefore that of providing foamable compositions which include less volatile plasticizers and allow faster processing at lower temperatures.

This technical problem is solved by a foamable composition containing a polymer selected from the group consisting of polyvinyl chloride, polyvinylidene chloride, polyvinyl butyrate, polyalkyl methacrylate and copolymers thereof, a foam former and/or foam stabilizer and diisononyl terephthalate as plasticizer, wherein the average degree of branching of the isononyl groups in the ester is in the range from 1.15 to 2.5, preferably in the range from 1.15 to 2.2, more preferably in the range from 1.15 to 1.95, even more preferably in the range from 1.25 to 1.85 and most preferably in the range from 1.25 to 1.45.

Surprisingly, a foamable composition containing as plasticizer a diisononyl terephthalate having the appropriate average degree of branching allows faster processing in the production of foamed polymer compositions from polyvinyl chloride or polyvinylidene chloride. It was found that, compared with plasticizers of the prior art, the plasticizers claimed provide a higher foam height notwithstanding increasing paste viscosity due to increasing branching. As a result, the corresponding pastes are faster to process, since they achieve higher foam heights within a shorter time, and/or provide overall processing at lower temperatures. This distinctly enhances the efficiency of the operation in the form of space-time yield, or energy efficiency.

It was further found that the paste viscosity of the foamable composition according to the invention is distinctly higher in some instances, compared with paste viscosities due to prior art plasticizers, but higher foaming can be achieved nonetheless. This is astonishing in as much as a higher paste viscosity generally also means a higher toughness/a higher “expansion resistance” and hence makes a lower ability to expand more likely. The higher foaming is possibly also attributable to the lower gelling rate of the foamable composition according to the invention, which is regarded as a disadvantage in the prior art but here is a distinct advantage. As a result, notwithstanding a significantly lower gelling rate and also an increased paste viscosity compared with foamable compositions of the prior art, faster processing is possible.

Faster processing is important in that it enables products to be produced more cost-effectively and more efficiently. For example, the machines used to apply the plastisols in the production of wall coverings, floor coverings and artificial leather for example can be run at distinctly higher rates of speed, thus increasing productivity. In this case in particular, the additional use of viscosity-lowering substances is only necessary to a small extent, if at all, with the use of the diisononyl terephthalates of the invention.

A further advantage is that the foamable compositions can be processed at lower temperatures and therefore also exhibit a distinctly lower yellowness index (caused by thermal decomposition), and at the same time any yellowness of the foamed composition due to the blowing agent (especially azodicarbonamide) and/or its incomplete decomposition ends up causing a lower yellowness index compared with plasticizers of the prior art.

It must further be noted that the diisononyl terephthalates of the invention are distinctly less volatile than isononyl benzoates used in foamable compositions of the prior art. This also facilitates the use for applications in interiors, since the plasticizers of the invention are less volatile and are less prone to escape from the plastic.

The method of determining the average degree of branching of the isononyl groups of the diisononyl terephthalate is described in what follows.

¹H NMR methods or ¹³C NMR methods can be used to determine the average degree of branching of the isononyl moieties in the terephthalic diester mixture. According to the present invention, it is preferable to determine the average degree of branching with the aid of ¹H NMR spectroscopy in a solution of the diisononyl esters in deuterochloroform (CDCl₃). The spectra are recorded by dissolving 20 mg of substance in 0.6 ml of CDCl₃ (comprising 1% by weight of TMS) and charging the solution to an NMR tube whose diameter is 5 mm. Both the substance to be studied and the CDCl₃ used can first be dried over a molecular sieve in order to exclude any errors in the values measured due to possible presence of water.

The method of determination of the average degree of branching is advantageous in comparison with other methods for the characterization of alcohol moieties, described by way of example in WO 03/029339, since water contamination in essence has no effect on the results measured and their evaluation. In principle, any commercially available NMR equipment can be used for the NMR-spectroscopic studies. The present NMR-spectroscopic studies used Avance 500 equipment from Bruker. The spectra were recorded at a temperature of 300 K using a delay of d1=5 seconds, 32 scans, a pulse length of 9.7 μs and a sweep width of 10 000 Hz, using a 5 mm BBO (broad band observer) probe head. The resonance signals are recorded in comparison with the chemical shifts of tetramethylsilane (TMS=0 ppm) as internal standard. Comparable results are obtained with other commercially available NMR equipment using the same operating parameters. The resultant ¹H NMR spectra of the mixtures of diisononyl esters of terephthalic acid have, in the range from 0.5 ppm as far as the minimum of the lowest value in the range from 0.9 to 1.1 ppm, resonance signals which in essence are formed by the signals of the hydrogen atoms of the methyl group(s) of the isononyl groups. The signals in the range of chemical shifts from 3.6 to 4.4 ppm can essentially be attributed to the hydrogen atoms of the methylene group adjacent to the oxygen of the alcohol or of the alcohol moiety. The results are quantified by determining the area under the respective resonance signals, i.e. the area included between the signal and the base line.

Commercially available NMR equipment has devices for integrating the signal area. In the present NMR-spectroscopic study, integration used “xwinnmr” software, version 3.5. The integral value of the signals in the range from 0.5 as far as the minimum of the lowest value in the range from 0.9 to 1.1 ppm is then divided by the integral value of the signals in the range from 3.6 to 4.4 ppm to give an intensity ratio which states the ratio of the number of hydrogen atoms present in a methyl group to the number of hydrogen atoms present in a methylene group adjacent to an oxygen. Since there are three hydrogen atoms per methyl group and two hydrogen atoms are present in each methylene group adjacent to an oxygen, each of the intensities has to be divided by 3 and, respectively, 2 in order to obtain the ratio of the number of methyl groups to the number of methylene groups adjacent to an oxygen, in the isononyl moiety. Since a linear primary nonanol which has only one methyl group and one methylene group adjacent to an oxygen contains no branching and accordingly must have an average degree of branching of 0, the quantity 1 then has to be subtracted from the ratio. The average degree of branching B can therefore be calculated from the measured intensity ratio in accordance with the following formula:

B=⅔*I(CH₃)/I(OCH₂)−1

B here means degree of branching, I(CH₃) means area integral essentially attributed to the methyl hydrogen atoms, and I(OCH₂) means area integral for the methylene hydrogen atoms adjacent to the oxygen.

The compositions of the invention may contain polymers selected from polyvinyl chloride (PVC), polyvinylidene chloride (PVDC), polyacrylates, especially polymethyl methacrylate (PMMA), polyalkyl methacrylate (PAMA), fluoropolymers, especially polyvinylidene fluoride (PVDF), polytetrafluoroethylene (PTFE), polyvinyl acetate (PVAc), polyvinyl alcohol (PVA), polyvinyl acetals, especially polyvinylbutyral (PVB), polystyrene polymers, especially polystyrene (PS), expandable polystyrene (EPS), acrylonitrile-styrene-acrylate (ASA), styrene-acrylonitrile (SAN), acrylonitrile-butadiene-styrene (ABS), styrene-maleic anhydride copolymer (SMA), styrene-methacrylic acid copolymer, polyolefins, especially polyethylene (PE) or polypropylene (PP), thermoplastic polyolefins (TPOs), polyethylene-vinyl acetate (EVA), polycarbonates, polyethylene terephthalate (PET), polybutylene terephthalate (PBT), polyoxymethylene (POM), polyamide (PA), polyethylene glycol (PEG), polyurethane (PU), thermoplastic polyurethane (TPU), polysulphides (PSus), biopolymers, especially polylactic acid (PLA), polyhydroxybutyric acid (PHB), polyhydroxyvaleric acid (PHV), polyester, starch, cellulose and cellulose derivatives, especially nitrocellulose (NC), ethylcellulose (EC), cellulose acetate (CA), cellulose acetate butyrate (CAB), rubber or silicones and also mixtures or copolymers of the polymers mentioned or of their monomeric units.

The compositions of the invention preferably include PVC or homo- or copolymers based on ethylene, propylene, butadiene, vinyl acetate, glycidyl acrylate, glycidyl methacrylate, methacrylates, acrylates, acrylates or methacrylates with alkyl radicals of branched or unbranched alcohols having one to ten carbon atoms attached to the oxygen atom of the ester group, styrene, acrylonitrile or cyclic olefins.

In one preferred embodiment, at least one polymer present in the foamable composition is selected from the group polyvinyl chloride, polyvinylidene chloride, polyvinyl butyrate, polyalkyl methacrylate and copolymers thereof.

In one particularly preferred embodiment, at least one polymer present in the foamable composition is a polyvinyl chloride (homo- or copolymer).

In a further particularly preferred embodiment, the polymer can be a copolymer of vinyl chloride with one or more monomers selected from the group consisting of vinylidene chloride, vinyl acetate, vinyl propionate, vinyl butyrate, vinyl benzoate, methyl acrylate, ethyl acrylate or butyl acrylate.

The amount of diisononyl terephthalate in the foamable composition is preferably in the range from 5 to 120 parts by mass, more preferably in the range from 10 to 100 parts by mass, even more preferably in the range from 15 to 90 parts by mass and most preferably in the range from 20 to 80 parts by mass per 100 parts by mass of polymer.

The foamable composition may additionally contain further additional plasticizers other than diisononyl terephthalate, in which case the solvation and/or gelling capacity of additional plasticizers can be higher than, the same as or lower than that of the diisononyl terephthalates of the invention. The mass ratio of employed additional plasticizers to the employed diisononyl terephthalates of the invention is particularly between 1:10 and 10:1, preferably between 1:10 and 8:1, more preferably between 1:10 and 5:1 and even more preferably between 1:10 and 1:1.

Additional plasticizers are particularly esters of ortho-phthalic acid, of isophthalic acid, of terephthalic acid, of cyclohexanedicarboxylic acid, of trimellitic acid, of citric acid, of benzoic acid, of isononanoic acid, of 2-ethylhexanoic acid, of octanoic acid, of 3,5,5-trimethylhexanoic acid and/or esters of butanol, pentanol, octanol, 2-ethylhexanol, isononanol, decanol, dodecanol, tridecanol, glycerol and/or isosorbide and also their derivatives and mixtures.

It is further preferable for the foamable composition of the invention to contain a foam former. This foam former can be a compound which evolves gas bubbles and which is optionally used together with what is known as a kicker. Kicker refers to catalysts which catalyse the thermal decomposition of the gas bubble evolver component, and cause the foam former to react by evolving a gas and cause the foamable composition to be foamed up. Foam formers are also termed blowing agents. In principle, the foamable composition can be foamed up chemically (i.e. by means of a blowing agent) or mechanically (i.e. by incorporation of gases, preferably air). As component evolving gas bubbles (blowing agent) it is preferable to use a compound which, on exposure to heat, decomposes into gaseous constituents which bring about expansion of the composition.

The blowing agents for foaming which are suitable for producing the polymer foams of the invention include all types of known blowing agents, physical and/or chemical blowing agents including inorganic blowing agents and organic blowing agents.

Examples of chemical blowing agents are azodicarbonamide, azobisisobutyronitrile, benzenesulphonyl hydrazide, 4,4-oxybenzenesulphonyl semicarbazide, 4,4-oxybis(benzenesulphonyl hydrazide), diphenyl sulphone 3,3-disulphonyl hydrazide, p-toluenesulphonyl semicarbazide, N,N-dimethyl-N,N-dinitrosoterephthalamide and trihydrazinetriazine, N═N-dinitrosopentamethylenetetramine, dinitrosotrimethyltriamine, sodium hydrogencarbonate, sodium bicarbonate, mixtures of sodium bicarbonate and citric acid, ammonium carbonate, ammonium bicarbonate, potassium bicarbonate, diazoaminobenzene, diazoaminotoluene, hydrazodicarbonamide, diazoisobutyronitrile, barium azodicarboxylate and 5-hydroxytetrazole.

It is particularly preferable for at least one of the blowing agents used to be azodicarbonamide which reacts to release gaseous components such as N₂, CO₂ and CO. The decomposition temperature of the blowing agent can be lowered by the kicker.

Mechanically foamed compositions are also termed “beaten foam”.

In principle, the foamable compositions of the invention can be plastisols for example.

It is further preferable for the foamable composition to contain a suspension, bulk, microsuspension or emulsion PVC. It is particularly preferable for at least one of the PVC polymers present in the composition of the invention to be a microsuspension PVC or an emulsion PVC. It is very particularly preferable for the foamable composition of the invention to include an emulsion PVC that has a molecular weight in terms of the K-value (Fikentscher constant) in the range from 60 to 90 and more preferably in the range from 65 to 85.

The foamable composition can further preferably comprise additives which in particular have been selected from the group consisting of fillers/reinforcing agents, pigments, matting agents, heat stabilizers, antioxidants, UV stabilizers, costabilizers, solvents, viscosity regulators, deaerating agents, flame retardants, adhesion promoters and processing aids or process aids (e.g. lubricants).

One of the functions of thermal stabilizers is to neutralize hydrochloric acid eliminated during and/or after the processing of the PVC, and to inhibit thermal degradation of the polymer. Thermal stabilizers which can be used are any of the customary polymer stabilizers, in particular any of the customary PVC stabilizers in solid or liquid form, for example those based on Ca/Zn, Ba/Zn, Pb, Sn or organic compounds (OBSs), and also acid-binding phyllosilicates such as hydrotalcite. The mixtures of the invention may contain from 0.5 to 10, preferably from 1 to 5 and more preferably from 1.5 to 4 parts by mass of thermal stabilizers per 100 parts by mass of polymer.

It is likewise possible to employ what are known as costabilizers having a plasticizing effect, more particularly epoxidized vegetable oils. It is very particularly preferable to use epoxidized linseed oil or epoxidized soya oil.

Antioxidants are generally substances that prevent the free-radical degradation of polymers which is caused by energetic radiation for example in a specific manner by for example forming stable complexes with the free radicals formed. Particular candidates for inclusion are sterically hindered amines—known as HALS stabilizers —, sterically hindered phenols, phosphites, UV absorbers such as, for example, hydroxybenzophenones, hydroxyphenylbenzotriazoles and/or aromatic amines. Suitable antioxidants for use in the compositions of the invention are also described for example in the “Handbook of Vinyl Formulating” (editor: R. F. Grossman; J. Wiley & Sons; New Jersey (US) 2008). The antioxidant content of the foamable mixtures of the invention is more particularly not more than 10 parts by mass, preferably not more than 8 parts by mass, more preferably not more than 6 parts by mass and even more preferably between 0.5 and 5 parts by mass per 100 parts by mass of polymer.

Both organic and inorganic pigments can be used as pigments for the purposes of the present invention. The pigment content is more particularly between 0.01 to 10 parts by mass, preferably 0.05 to 8 parts by mass and even more preferably 0.1 to 5 parts by mass per 100 parts by mass of polymer. Examples of inorganic pigments are TiO₂, CdS, CoO/Al₂O₃, Cr₂O₃. Examples of known organic pigments are azo dyes, phthalocyanine pigments, dioxazine pigments, carbon black and also aniline pigments. It is also possible to use effect pigments based on mica or synthetic supports for example.

Viscosity regulators can effectuate not only a general lowering in paste/plastisol viscosity (viscosity-lowering reagents or additives) but also change the course of the viscosity (curve) as a function of the shear rate. Viscosity-lowering reagents which can be used comprise aliphatic or aromatic hydrocarbons, but also carboxylic acid derivatives such as, for example, 2,2,4-trimethyl-1,3-pentanediol diisobutyrate, known as TXIB (from Eastman), or else mixtures of carboxylic esters, wetting agents and dispersing agents as known for example by the product/trade names of Byk, Viskobyk and Disperplast (from Byk Chemie). Viscosity-lowering reagents are added in proportions of 0.5 to 50, preferably 1 to 30 and more preferably 2 to 10 parts by mass per 100 parts by mass of polymer.

Fillers that can be used are mineral and/or synthetic and/or natural, organic and/or inorganic materials, e.g. calcium oxide, magnesium oxide, calcium carbonate, barium sulphate, silicon dioxide, phyllosilicate, carbon black, bitumen, wood (e.g. pulverized, in the form of granules or microgranules or fibres, etc.), paper, and natural and/or synthetic fibres. The following are preferably used for the compositions of the invention: calcium carbonates, silicates, talc powder, kaolin, mica, feldspar, wollastonite, sulphates, carbon black and microspheres (in particular glass microspheres). It is particularly preferable that at least one of the fillers used is a calcium carbonate. Frequently used fillers and reinforcing agents for PVC formulations are also described by way of example in “Handbook of Vinyl Formulating” (Editor: R. F. Grossman; J. Wiley & Sons; New Jersey (US) 2008). The amounts of fillers used in the compositions of the invention are advantageously at most 150 parts by mass, preferably at most 120, particularly preferably at most 100 and with particular preference at most 80 parts by mass per 100 parts by mass of polymer. In one advantageous embodiment, the total proportion of the fillers used in the formulation of the invention is at most 90 parts by mass, preferably at most 80, particularly preferably at most 70 and with particular preference from 1 to 60 parts by mass per 100 parts by mass of polymer.

By way of foam stabilizers, the composition of the invention may include commercially available foam stabilizers as named in DE 10026234 C1 for example. More particularly, the preferred foam stabilizers contain surface-active substances such as, for example, alkali and/or alkaline earth metal salts of aromatic sulphonic acids such as, for example, of alkylbenzenesulphonic acids and also further aromatic compounds. Foam stabilizers can also be based on silicone compounds and/or contain surfactants. Stabilizers based on soap/surfactant contain calcium dodecylbenzenesulphonates as active component for example. Foam stabilizers based on silicone or based on soap are commercially available for example under the brand names Byk 8020 and Byk 8070 (from Byk Chemie). The foam stabilizers are used in amounts of 1 to 10 parts by mass, preferably 1 to 8 and more preferably 2 to 4 parts by mass per 100 parts by mass of polymer.

The patent further provides for the use of the foamable composition for floor coverings, wall coverings or artificial leather. The invention further provides a floor covering containing the foamable composition of the invention, a wall covering containing the foamable composition of the invention or artificial leather containing the foamable composition of the invention.

The diisononyl terephthalates having an average degree of branching of from 1.15 to 2.5 are produced in accordance with the description in WO 2009/095126 A1. This is preferably achieved via using a mixture of isomeric primary nonanols for transesterification of terephthalic esters having alkyl moieties which have less than 8 carbon atoms. The production process particularly preferably uses a mixture of isomeric primary nonanols for transesterification of dimethyl terephthalate. As an alternative, it is also possible to use a mixture of primary nonanols having the appropriate abovementioned degrees of branching to produce the diisononyl terephthalate via esterification of terephthalic acid.

Examples of materials marketed for producing the diisononyl terephthalates are particularly suitable nonanol mixtures from Evonik Oxeno which generally have an average degree of branching of from 1.1 to 1.4, in particular from 1.2 to 1.35, and also nonanol mixtures from Exxon Mobil (Exxal 9) which have a degree of branching of up to 2.4. Another possibility is moreover the use of mixtures of nonanols having a low degree of branching, in particular of nonanol mixtures having a degree of branching of at most 1.5, and/or of nonanol mixtures using highly branched nonanols available in the market, e.g. 3,5,5-trimethylhexanol. The latter procedure permits specific adjustment of the average degree of branching within the stated limits.

The nonyl terephthalates used in the invention have the following features with respect to their thermal properties (determined via differential calorimetry/DSC):
1. They have at least one glass transition temperature in the first heating curve (start temperature: −100° C., end temperature: +200° C.; heating rate: 10 K/min.) of the DSC thermogram.
2. At least one of the glass transition temperatures detected in the above-mentioned DSC measurement is below a temperature of −70° C., preferably below −72° C., particularly preferably below −75° C. and with particular preference below −77° C. In one advantageous embodiment, in particular when the intention is to produce plastisols or polymer foams with particularly good low-temperature flexibility, at least one of the glass transition temperatures detected in the above-mentioned DSC measurement is below a temperature of −75° C., preferably below −77° C., particularly preferably below −80° C. and with particular preference below −82° C.
3. They have no detectable melting signal (and thus an enthalpy of fusion of 0 J/g) in the first heating curve (start temperature: −100° C., end temperature: +200° C.; heating rate: 10 K/min.) of the DSC thermogram.

The glass transition temperature, and also the enthalpy of fusion, can be adjusted by way of the selection of the alcohol component used for the esterification process, or the alcohol mixture used for the esterification process.

The shear viscosity at 20° C. of the terephthalic esters used in the invention is at most 142 mPa*s, preferably at most 140 mPa*s, particularly preferably at most 138 mPa*s and with particular preference at most 136 mPa*s. In one advantageous embodiment, in particular when the intention is to produce plastisols of particularly low viscosity which are suitable by way of example for very fast processing, the shear viscosity at 20° C. of the terephthalic esters used in the invention is at most 120 mPa*s, preferably at most 110 mPa*s, particularly preferably at most 105 mPa*s and with particular preference at most 100 mPa*s. The shear viscosity of the terephthalic esters of the invention can be specifically adjusted via the use, for the production of the same, of isomeric nonyl alcohols having a particular (average) degree of branching.

The loss in mass of the terephthalic esters used in the invention after 10 minutes at 200° C. is at most 4% by mass, preferably at most 3.5% by mass, particularly preferably at most 3% by mass and with particular preference at most 2.9% by mass. In one advantageous embodiment, in particular when the intention is to produce polymer foams with low emissions, the loss in mass of the terephthalic esters used in the invention after 10 minutes at 200° C. is at most 3% by mass, preferably at most 2.8% by mass, particularly preferably at most 2.6% by mass and with particular preference at most 2.5% by mass. The loss in mass can be specifically influenced and/or adjusted via the selection of the constituents of the formulation, and also in particular via the selection of diisononyl terephthalates having a particular degree of branching.

The (liquid) density of the terephthalic esters used in the invention, determined by means of an oscillating U-tube (for purity of at least 99.7 area % according to GC analysis and a temperature of 20° C.) is at least 0.9685 g/cm³, preferably at least 0.9690 g/cm³, particularly preferably at least 0.9695 g/cm³ and with particular preference at least 0.9700 g/cm³. In one advantageous embodiment, the (liquid) density of the terephthalic esters used in the invention, determined by means of an oscillating U-tube (for purity of at least 99.7 area % according to GC analysis and a temperature of 20° C.), is at least 0.9700 g/cm³, preferably at least 0.9710 g/cm³, particularly preferably at least 0.9720 g/cm³ and with particular preference at least 0.9730 g/cm³. The density of the terephthalic esters of the invention can be specifically adjusted by using, for the production of the same, isomeric nonyl alcohols of particular (average) degree of branching.

The foamable composition of the invention can be produced in various ways. However, the composition is generally produced via intensive mixing of all of the components in a suitable mixing container. The components here are preferably added in succession (see also: “Handbook of Vinyl Formulating” (Editor: R. F. Grossman; J. Wiley & Sons; New Jersey (US) 2008)).

The foamable composition of the invention can be used for producing foamed mouldings. It is particularly preferable for the foamable compositions of the invention to contain at least a polymer selected from the group polyvinyl chloride or polyvinylidene chloride or copolymers thereof.

Examples of foamed products of this type are artificial leather, floor coverings or wall coverings, particular preference being given to the use of the foamed products in cushion vinyl (CV) floorings and wall coverings.

The foamed products from the foamable composition of the invention are obtained more particularly by initially applying the foamable composition to a support or a further polymeric layer and foaming the composition before, during or after application, and finally subjecting the applied and/or foamed composition to thermal processing (i.e. by exposure to thermal energy, for example by heating/warming).

Foaming can be effected mechanically, physically or chemically. Mechanical foaming of a composition or plastisol is to be understood as meaning that the plastisol before application to the support has for example by sufficiently vigorous stirring air (or other gaseous substances) introduced into it (so-called “beaten foam”), which leads to foaming up. Stabilizing the foam thus formed generally necessitates a stabilizer. The foam stabilizers used determine in particular cell structure, colour and water absorbency of the final foam. The choice of stabilizer type is also dependent inter alia on the plasticizers which are to be used.

In addition to the foam stabilizer, further auxiliary substances can be added to influence and/or additionally stabilize the foam structure. Glycol dibenzoates are concerned here in particular. Glycol dibenzoates are essentially diethylene glycol dibenzoate (DEGDB), triethylene glycol dibenzoate (TEGDB) and dipropylene glycol dibenzoate (DPGDB) or mixtures thereof.

In addition to mechanical foaming by vigorous stirring for example, the foamable compounds of the invention can also be foamed up physically using blowing gases, in which case these are mixed together with the plastisol of the invention in suitable technical apparatus under pressure and subsequently expanded under lower pressure. As physical blowing agents, both organic and inorganic substances can be used. Suitable inorganic blowing agents include carbon dioxide, nitrogen, argon, water, air, oxygen and helium.

Organic blowing agents include aliphatic hydrocarbons of 1-6 carbon atoms, aliphatic alcohols of 1-3 carbon atoms and fully or partially halogenated aliphatic hydrocarbons of 1-4 carbon atoms. Aliphatic hydrocarbons include methane, ethane, propane, n-butane, isobutane, n-pentane, isopentane, neopentane, hexane, isohexane, heptane, octane, methylpentane, dimethylpentane, butene, pentene, 4-methylpentene, hexene, heptene, 2,2-dimethylbutane and petroleum ether. Aliphatic alcohols include methanol, ethanol, n-propanol and isopropanol. Fully and partially halogenated aliphatic hydrocarbons include (hydro)chlorocarbons, (hydro)fluorocarbons and also (hydro)chlorofluorocarbons. (Hydro)chlorocarbons for use in this invention include methyl chloride, methylene chloride, ethyl chloride, ethylene dichloride, 1,1,1-trichloroethane, trichloromethane and tetrachloromethane. Hydrofluorocarbons for use in this invention include methyl fluoride, methylene fluoride, ethyl fluoride, 1,1-difluoroethane (HFC-152a), 1,1,1-trifluoroethane (HFC-143a), 1,1,1,2-tetrafluoroethane (HFC-134a), 1,1,2,2,-tetrafluoroethane (HFC-134), pentafluoroethane, 2,2-difluoropropane, 1,1,1-trifluoropropane and 1,1,1,3,3-pentafluoropropane. Hydrochlorofluorocarbons for use in this invention include chlorofluoromethane, chlorodifluoromethane (HCFC-22), 1,1-dichloro-1-fluoroethane (HCFC-141b), 1-chloro-1,1-difluoroethane (HCFC-142b), 1,1-dichloro-2,2,2-trifluoroethane (HCFC-123), 1,2-dichloro-1,2,2-trifluoroethane (HCFC-123a) and 1-chloro-1,2,2,2-tetrafluoroethane (HCFC-124). Fully halogenated hydrocarbons can also be used, but are less preferable for ecological reasons: fluorotrichloromethane (CFC-11), dichlorodifluoromethane (CFC-12), 1,1,2-trichloro-1,2,2-trifluoroethane (CFC-113), 1,2-dichloro-1,1,2,2-tetrafluoroethane (CFC-114), chloro-1,1,2,2,2-pentafluoroethane (CFC-115), trichlorofluoromethane. More particularly, foam stabilizers and/or further auxiliary substances to influence the foam structure are also used in the physical foaming by use of blowing gases.

In the case of chemical foaming, the composition of the invention contains a blowing agent which, on exposure to heat, decomposes wholly or overwhelmingly into gaseous constituents which bring about an expansion of the composition. The decomposition temperature of the blowing agent can be distinctly lowered by addition of catalysts. These catalysts are known to a person skilled in the art as “kickers”, and can be added either separately or preferably as a system together with the thermal stabilizer. Preferably, the composition of the invention contains at least one calcium, zinc or barium compound. The use of a foam stabilizer can be optionally dispensed with in chemical foaming in contrast to mechanical foam.

Unlike mechanical foam, chemical foams are only formed in the course of (thermal) processing, generally in a heated gelling tunnel, while initially the still unfoamed composition is applied to the support, preferably by spread coating. With this mode of performing the process, profiling the foam can be achieved through selective application of inhibitor solutions, for example via a rotary screen printing rig. In those places where the inhibitor solution was applied, plastisol expansion during processing only takes place with delay, if at all. In commercial practice, chemical foaming is distinctly more popular than mechanical foaming. Further information concerning chemical and mechanical foaming is discernible from, for example, E. J. Wickson, “Handbook of Vinyl Formulating” (editor: R. F. Grossman, John Wiley & Sons New Jersey (US) 2008) or the technical textbook “Polymeric Foams and Foam Technology” (D. Klempner, V. Sendijarevic; Hanser-Verlag; Munich; 2004). Optionally, (further) profiling can also be achieved subsequently through what is known as mechanical embossing using an embossing roll for example.

Both processes can utilize support materials that remain firmly attached to the foam produced, examples being woven or nonwoven webs. Similarly, the supports may also be merely temporary supports, from which the foams produced can be removed again as layers of foam. Such supports can be, for example, metal belts or release paper (Duplex paper). Another polymeric layer, if appropriate one which has previously been completely or partially (=pre-gelled) gelled, may also function as a support. This method is practised particularly in the case of CV floor coverings constructed of two or more layers.

In both cases, the final thermal treatment takes place in what is known as a gelling tunnel, generally an oven, through which the layer applied to the support and composed of the composition of the invention is passed, or into which the support to which the layer has been applied is introduced for a short period. The final thermal treatment serves to solidify (gel) the foamed layer. In the case of chemical foaming, the gelling tunnel may be combined with an apparatus serving to produce the foam. It is possible, for instance, to use only one gelling tunnel, in the upstream portion of which, at a first temperature, the foam is produced chemically by decomposition of a gas-forming component, this foam being converted in the downstream portion of the gelling tunnel, at a second temperature which is preferably higher than the first temperature, into the finished or semi-finished product.

Depending on the composition, it is also possible for gelling and foaming to take place simultaneously at a single temperature. Typical processing temperatures (gelling temperatures) are in the range from 130 to 280° C. and preferably in the range from 150 to 250° C. In the preferred manner of gelling, the foamed composition is treated at the gelling temperatures mentioned for a period of 0.2 to 5 minutes, preferably for a period of 0.5 to 3 minutes. In the case of processes which operate continuously, the duration of the heat treatment here may be adjusted via the length of the gelling tunnel and the speed at which the support with the foam on top passes therethrough. Typical foaming temperatures (chemical foam) are in the range from 160 to 240° C., preferably from 170 to 220° C. and are especially preferably between 180 and 215° C.

In the case of multilayered systems, the shape of the individual layers is generally firstly fixed by what is known as pre-gelling of the applied plastisol at a temperature below the decomposition temperature of the blowing agent, and after this other layers (e.g. an overlayer) may be applied. Once all the layers have been applied, a higher temperature is used for the gelling—and also for the foam-forming process in the case of chemical foaming. The desired profiling can also be extended to the overlayer by this procedure.

The foamable compositions of the invention are advantageous over the prior art in that they can be processed more rapidly at lower temperatures, and hence appreciably improve the efficiency of the manufacturing operation for PVC foams. Furthermore, the plasticizers used in the PVC foam are less volatile, and hence the PVC foam is also particularly suitable for interior applications in particular. It is believed that a person skilled in the art can use the above description in the widest scope even without further details being given. The preferred embodiments and examples are therefore to be understood as merely descriptive disclosure and in no way as a disclosure which is in any way limiting. The present invention is hereinbelow further elucidated by means of examples. Alternative embodiments of the present invention are obtainable in a similar fashion.

### EXAMPLES

### Analysis

### 1. Determination of Purity

The purity of the esters produced is determined by means of GC, using a “6890N” GC machine from Agilent Technologies and a DB-5 column (length: 20 m, internal diameter: 0.25 mm, film thickness 0.25 μm) from J&W Scientific and a flame ionization detector, under the following conditions:

| Oven starting temperature: 150° C. | Oven final temperature: 350° C. |
|---|---|
| (1) Heating rate from 150 to | (2) Isothermal: 10 min. at 300° C. |
| 300° C.: 10 K/min | |
| (3) Heating rate from 300 to | |
| 350° C.: 25 K/min. | |
| Total running time: 27 min. | |
| Ingoing temperature of injection | Split ratio: 200:1 |
| block: 300° C. | |
| Split flow rate: 121.1 ml/min | Total flow rate: 124.6 ml/min. |
| Carrier gas: Helium | Injection volume: 3 microlitres |
| Detector temperature: 350° C. | Combustion gas: Hydrogen |
| Hydrogen flow rate: 40 ml/min. | Air flow rate: 440 ml/min. |
| Makeup gas: Helium | Flow rate of makeup gas: 45 ml/min. |

The gas chromatograms obtained are evaluated manually against available comparative substances (di(isononyl) orthophthalate/DINP, di(isononyl) terephthalate/DINT), and purity is stated in area percent. Because the final contents of target substance are high at >99.7%, the probable error due to lack of calibration for the respective sample substance is small.

### 2. Determination of Degree of Branching

The degree of branching of the esters produced is determined by means of NMR spectroscopy, using the method described in detail above.

### 3. Determination of APHA Colour Index

The colour index of the esters produced was determined to DIN EN ISO 6271-2.

### 4. Determination of Density

The density of the esters produced was determined at 20° C. by means of an oscillating U-tube to DIN 51757—Method 4.

### 5. Determination of Acid Number

The acid number of the esters produced was determined to DIN EN ISO 2114.

### 6. Determination of Water Content

The water content of the esters produced was determined to DIN 51777 Part 1 (Direct Method).

### 7. Determination of Intrinsic Viscosity

The intrinsic viscosity (shear viscosity) of the esters produced was determined by using a Physica MCR 101 (Anton-Paar) with Z3 measurement system (DIN 25 mm) in rotation mode by the following method:

Ester and measurement system were first controlled to a temperature of 20° C., and then the following procedures were activated by the “Rheoplus” software:

1. Preshear at 100 s⁻¹ for a period of 60 s with no measured values recorded (in order to achieve stabilization with respect to any thixotropic effects that may arise and to improve temperature distribution).
2. A decreasing shear rate profile, starting at 500 s⁻¹ and ending at 10 s⁻¹, divided into a logarithmic series with 20 steps each with measurement point duration of 5 s (verification of Newtonian behaviour).

All of the esters exhibited Newtonian flow behaviour. The viscosity values have been stated by way of example at a shear rate of 42 s⁻¹.

### 8. Determination of Loss of Mass

Loss of mass at 200° C. from the esters produced was determined with the aid of a Mettler halogen dryer (HB43S). Measurement parameters set were as follows:

Temperature profile: Constant 200° C.
Measured value recording: 30 s
Measurement time: 10 min
Amount of specimen: 5 g

The measurement process used disposable aluminium dishes (Mettler) and an HS 1 fibre filter (glass non-woven from Mettler). After stabilization and taring of the balance, the specimens (5 g) were uniformly distributed on the fibre filter with the aid of a disposable pipette, and the measurement process was started. Two determinations were carried out for each specimen and the measured values were averaged. The final measured value after 10 min is stated as “Loss of mass after 10 minutes at 200° C.”.

### 9. DSC Analysis Method, Determination of Enthalpy of Fusion

Enthalpy of fusion and glass transition temperature were determined by differential calorimetry (DSC) to DIN 51007 (temperature range from −100° C. to +200° C.) from the first heating curve at a heating rate of 10 K/min. Before the measurement process, the specimens were cooled to −100° C. in the measurement equipment used, and then heated at the heating rate stated. The measurement was carried out under nitrogen as inert gas. The inflection point of the heat flux curve is taken as the glass transition temperature. Enthalpy of fusion is determined via integration of the peak area(s), by using software in the equipment.

10. Determination of Plastisol Viscosity The viscosity of the PVC plastisols was measured using a Physica MCR 101 (Anton-Paar) with “Z3” measurement system (DIN 25 mm) in rotation mode.

The plastisol was first homogenized manually with a spatula in the mixing container and then charged to the measurement system and measured isothermally at 25° C. The procedures activated during the measurement were as follows:

1. Preshear at 100 s⁻¹ for a period of 60 s with no measured values recorded (in order to achieve stabilization with respect to any thixotropic effects that may arise).
2. A decreasing shear rate profile, starting at 200 s⁻¹ and ending at 0.1 s⁻¹, divided into a logarithmic series with 30 steps each with measurement point duration of 5 seconds.

The measurements were generally (unless otherwise stated) carried out after 24 h of storage/ageing of the plastisols. The plastisols were stored at 25° C. prior to the measurements.

### 11. Determination of Gelling Rate

The gelling behaviour of the plastisols was studied in a Physica MCR 101 in oscillation mode using a plate-on-plate measurement system (PP25), operated with shear-stress control. An additional temperature-control hood was attached to the equipment in order to optimize heat distribution.

### Measurement Parameters:

Mode: Temperature gradient (temperature profile)
Starting temperature: 25° C.
Final temperature: 180° C.
Heating/cooling rate: 5 K/min
Oscillation frequency: from 4 to 0.1 Hz profile (logarithmic)
Angular frequency Omega: 10 l/s
Number of measurement points: 63
Measurement point duration: 0.5 min
No automatic gap adjustment
Constant measurement point duration
Gap width 0.5 mm

### Measurement Method:

A spatula was used to apply a drop of the plastisol formulation to be measured, free from air bubbles, to the lower plate of the measurement system. Care was taken here to ensure that some plastisol could exude uniformly out of the measurement system (not more than about 6 mm overall) after the measurement system had been closed. The temperature-control hood was then positioned over the specimen and the measurement was started. The “complex viscosity” of the plastisol was determined as a function of temperature. The onset of the gelling process was discernible via a sudden marked rise in complex viscosity. The earlier the onset of this viscosity rise, the better the gelling capability of the system.

Interpolation was used on the resultant measured curves to determine, for each plastisol, the temperature at which a complex viscosity of 1000 Pa*s or, respectively, 10 000 Pa*s had been reached. In addition, a tangent method was used to determine the maximum plastisol viscosity reached in this experimental system, and the temperature from which maximum plastisol viscosity occurs was determined by dropping a perpendicular.

### 12. Production of Foam Foils and Determination of Expansion Rate

Foaming behaviour was determined using a thickness gauge suitable for plasticized PVC measurements (KXL047 from Mitutoyo) to an accuracy of 0.01 mm. A Mathis Labcoater (type: LTE-TS; manufacturer: W. Mathis AG) was used for foil production after adjustment of the roll blade to a blade gap of 1 mm. This blade gap was checked with a feeler gauge and adjusted if necessary. The plastisols were coated with the roll blade of the Mathis Labcoater onto a release paper (Warren Release Paper; from Sappi Ltd.) stretched flat in a frame. To be able to compute percentage foaming, first an incipiently gelled and unfoamed foil was produced at 200° C./30 seconds' residence time. The thickness of this foil (=Original thickness) was in all cases between 0.74 and 0.77 mm at the stated blade gap. Thickness was measured at three different points of the foil.

Foamed foils (foams) were then likewise produced with/in the Mathis Labcoater at 4 different oven residence times (60 s, 90 s, 120 s and 150 s). After the foams had cooled down, the thicknesses were likewise measured at three different points. The average value of the thicknesses and the original thickness were needed to compute the expansion. (Example: (foam thickness-original thickness)/original thickness*100%=expansion).

### 13. Determination of Yellowness Index

The YD 1925 yellowness index is a measure of yellow discoloration of a sample specimen. This yellowness index is of interest in the assessment of foam sheets in two respects. First, it indicates the degree of decomposition of the blowing agent azodicarbonamide (yellow in the undecomposed state) and, secondly, it is a measure of thermal stability (discolorations due to thermal stress). Colour measurement of the foam sheets was done using a Spectro Guide from Byk-Gardner. A (commercially available) white reference tile was used as background for the colour measurements. The following settings were used:

### Illuminate: C/2°

Number of measurements: 3

### Display: CIE L*a*b*

Index measured: YD1925

The measurements themselves were carried out at 3 different points of the samples (at a plastisol blade thickness of 200 μm for effect and flat foams). The values obtained from the 3 measurements were averaged.

### Example 1

### Production of Terephthalic Esters

1.1 Production of Diisononyl Terephthalate (DINT) from Terephthalic Acid and Isononanol from Evonik Oxeno GmbH (in the Invention)

644 g of terephthalic acid (Sigma Aldrich Co.), 1.59 g of tetrabutyl orthotitanate (Vertec TNBT, Johnson Matthey Catalysts) and 1440 g of an isononanol (Evonik OXENO GmbH) produced by way of the OCTOL process were used as initial charge in a 4 litre stirred flask with water separator and superposed high-performance condenser, stirrer, immersed tube, dropping funnel and thermometer, and the mixture was esterified as far as 240° C. After 8.5 hours, the reaction had ended. The excess alcohol was then removed by distillation as far as 190° C. and <1 mbar. The mixture was then cooled to 80° C. and neutralized using 8 ml of a 10% strength by mass aqueous NaOH solution. Steam distillation was then carried out at a temperature of 180° C. and at a pressure of from 20 to 5 mbar. The mixture was then cooled to 130° C. and dried at 5 mbar at this temperature. After cooling to <100° C., the mixture was filtered through filter aid (perlite). The resultant ester content (purity) according to GC was 99.9%.

1.2 Production of Diisononyl Terephthalate (DINT) from Dimethyl Terephthalate (DMT) and Isononanol from Evonik Oxeno GmbH (in the Invention)

776 g of dimethyl terephthalate/DMT (Oxxynova), 1.16 g of tetrabutyl orthotitanate (Vertec TNBT, Johnson Matthey Catalysts) and initially 576 g of the total of 1440 g of isononanol (Evonik OXENO GmbH) were used as initial charge in a 4 litre stirred flask with distillation bridge with reflux divider, 20 cm Multifill column, stirrer, immersed tube, dropping funnel and thermometer. The mixture was slowly heated, with stirring, until no residual solid was visible. Heating was continued until the reflux divider produced methanol. The reflux divider was adjusted in such a way as to keep the overhead temperature constant at about 65° C. Starting at a bottom temperature of about 240° C., the remaining alcohol was added slowly in such a way as to keep the temperature in the flask constant and maintain adequate reflux. From time to time, a specimen was studied by means of GC, and diisononyl terephthalate content and methyl isononyl terephthalate content were determined. The transesterification process was terminated when methyl isononyl terephthalate content was <0.2 area % (GC). The work-up was analogous to the work-up described in Example 1.1.

1.3 Production of Diisononyl Terephthalate (DINT) from Terephthalic Acid and Isononanol from ExxonMobil (in the Invention)

830 g of terephthalic acid (Sigma Aldrich Co.), 2.08 g of tetrabutyl orthotitanate (Vertec TNBT, Johnson Matthey Catalysts) and 1728 g of an isononanol (Exxal 9, ExxonMobil Chemicals) produced by way of the polygas process were used as initial charge in a 4 litre stirred flask with water separator and superposed high-performance condenser, stirrer, immersed tube, dropping funnel and thermometer, and the mixture was esterified at 245° C. After 10.5 hours, the reaction had ended. The excess alcohol was then removed by distillation at 180° C. and 3 mbar. The mixture was then cooled to 80° C. and neutralized using 12 ml of a 10% strength by mass aqueous NaOH solution. Steam distillation was then carried out at a temperature of 180° C. and at a pressure of from 20 to 5 mbar. The mixture was then dried at 5 mbar at this temperature and, after cooling to <100° C., filtered. The resultant ester content (purity) according to GC was 99.9%.

1.4 Production of Diisononyl Terephthalate (DINT) from Terephthalic Acid and n-Nonanol (Comparative Example)

By analogy with Example 1.1, n-nonanol (Sigma Aldrich Co.), instead of the isononanol, was esterified with terephthalic acid and worked up as described above. The product, which according to GC had >99.8% ester content (purity), solidified on cooling to room temperature.

1.5 Production of Diisononyl Terephthalate (DINT) from Terephthalic Acid and 3,5,5-Trimethylhexanol (Comparative Example)

By analogy with Example 1.1, 3,5,5-trimethylhexanol (OXEA GmbH), instead of the isononanol, was esterified with terephthalic acid and worked up as described above. The product, which according to GC had >99.5% ester content (purity), solidified on cooling to room temperature.

1.6 Production of Diisononyl Terephthalate (DINT) from Terephthalic Acid, Isononanol and 3,5,5-Trimethylhexanol (Comparative Example)

166 g of terephthalic acid (Sigma Aldrich Co.), 0.10 g of tetrabutyl orthotitanate (Vertec TNBT, Johnson Matthey Catalysts) and an alcohol mixture made of 207 g of an isononanol (Exxal 9, ExxonMobil Chemicals) produced by way of the polygas process and 277 g of 3,5,5-trimethylhexanol (OXEA GmbH) were used as initial charge in a 2 litre stirred flask with water separator, high-performance condenser, stirrer, immersed tube, dropping funnel and thermometer, and were esterified as far as 240° C. After 10.5 hours, the reaction had ended. The stirred flask was then attached to a Claisen bridge with vacuum divider, and the excess alcohol was removed by distillation as far as 190° C. and <1 mbar. The mixture was then cooled to 80° C. and neutralized using 1 ml of a 10% strength by mass aqueous NaOH solution. The mixture was then purified via passage of nitrogen (“stripping”) at a temperature of 190° C. and a pressure of <1 mbar.

The mixture was then cooled to 130° C., and dried at <1 mbar at this temperature and, after cooling to 100° C., filtered. The resultant ester content (purity) was 99.98% according to GC.

1.7 Production of Diisononyl Terephthalate (DINT) from Terephthalic Acid, Isononanol and 3,5,5-Trimethylhexanol (in the Invention)

166 g of terephthalic acid (Sigma Aldrich Co.), 0.10 g of tetrabutyl orthotitanate (Vertec TNBT, Johnson Matthey Catalysts) and an alcohol mixture made of 83 g of an isononanol (Exxal 9, ExxonMobil Chemicals) produced by way of the polygas process and 153 g of 3,5,5-trimethylhexanol (OXEA GmbH) were used as initial charge in a 2 litre stirred flask with water separator, high-performance condenser, stirrer, immersed tube, dropping funnel and thermometer, and were esterified as far as 240° C. After 10.5 hours, the reaction had ended. The stirred flask was then attached to a Claisen bridge with vacuum divider, and the excess alcohol was removed by distillation as far as 190° C. and <1 mbar. The mixture was then cooled to 80° C. and neutralized using 1 ml of a 10% strength by mass aqueous NaOH solution. The mixture was then purified via passage of nitrogen (“stripping”) at a temperature of 190° C. and a pressure of <1 mbar. The mixture was then cooled to 130° C., and dried at <1 mbar at this temperature and, after cooling to 100° C., filtered. The resultant ester content (purity) was 99.98% according to GC.

Characteristic parameters of materials for the esters obtained in 1 have been collated in Table 1.

TABLE 1
Parameters of materials of the terephthalic esters produced in Example 1 (examples of the invention and comparative examples)

| | | | | | | | | Loss of mass | | |
|---|---|---|---|---|---|---|---|---|---|---|
| | | Degree of | | | Acid | | | after 10 | | |
| | Purity | branching | APHA | | number | Water | Intrinsic | minutes | DSC | |
| Product | (GC) | (NMR) | colour | Density | [mg | content | viscosity | @200° C. | T_{g} | ΔH_{M} |
| (according to example) | [Area %] | [—] | [—] | [g/cm³] | KOH/g] | [%] | [mPa * s] | [% by mass] | [° C.] | [J/g] |
| Di(n-nonyl) | 99.75 | 0 | n.db. | n.db. | 0.013 | 0.035 | n.db. | 1.2 | none | 158.2 |
| terephthalate | | | | (solid) | | | (solid) | | | |
| (Example 1.4/ | | | | | | | | | | |
| comparative example) | | | | | | | | | | |
| Di(nonyl) terephthalate | 99.97 | 1.32 | 2 | 0.9743 | 0.01 | 0.007 | 96 | 2.2 | −86 | 0 |
| (Example 1.1/in the | | | | | | | | | | |
| invention) | | | | | | | | | | |
| Di(nonyl) terephthalate | 99.8 | 2.13 | 29 | 0.9724 | 0.001 | 0.003 | 136 | 2.2 | −78 | 0 |
| (Example 1.3/in the | | | | | | | | | | |
| invention) | | | | | | | | | | |
| Di(3,5,5-trimethylhexyl) | 99.76 | 2.99 | n.db. | n.db. | 0.016 | 0.01 | n.db. | 2.7 | none | 107.4 |
| terephthalate (Example | | | | (solid) | | | (solid) | | | |
| 1.5/comparative | | | | | | | | | | |
| example) | | | | | | | | | | |
| Di(nonyl) terephthalate | 99.98 | 2.49 | 14 | 0.9704 | 0.013 | 0.019 | 140 | 2.5 | −73 | 0 |
| (Example 1.7/in the | | | | | | | | | | |
| invention) | | | | | | | | | | |
| Di(nonyl) terephthalate | 99.98 | 2.78 | 90 | 0.9681 | 0.03 | 0.011 | 145 | 2.6 | −69 | 44.6 |
| (Example 1.6/ | | | | | | | | | | |
| comparative example) | | | | | | | | | | |
| Isononyl benzoate, | 99.97 | 1.3 | 7 | 0.9585 | 0.038 | 0.018 | 8.3 | 64.6 | −100*** | 0 |
| VESTINOL ® INB, from | | | | | | | | | | |
| Evonik Oxeno GmbH | | | | | | | | | | |
| (comparative | | | | | | | | | | |
| example) | | | | | | | | | | |
| Di(isononyl) phthalate, | 99.95 | 1.3 | 5 | 0.9741 | 0.016 | 0.023 | 76 | 3.7 | −86 | 0 |
| VESTINOL ® 9, Evonik | | | | | | | | | | |
| Oxeno GmbH | | | | | | | | | | |
| (comparative | | | | | | | | | | |
| example) | | | | | | | | | | |

n.db. = not determinable (e.g.: determination method used requires liquid phase at room temperature).
n.d. = not determined
***= starting temperature (DSC): −150° C.

The difference between the isononyl benzoate (INB) described in the prior art for the production of polymer foams and the diisononyl terephthalates used according to the invention becomes particularly clear through the dramatic difference in volatility (loss of mass after 10 minutes at 200° C.). Isononyl benzoate is found to give a 20 times higher value. This high volatility is the reason why INB can only be used to a limited extent in many interior applications, if at all.

When unbranched alcohol (n-nonanol; degree of branching=0) is used to produce the terephthalic esters, the product, as would be expected, is the unbranched terephthalate. At room temperature this is a solid, and conventional methods cannot use this to produce a plastisol. Even when the degree of branching is high, about 3, as is obtained by way of example when 3,5,5-trimethylhexanol is used exclusively as alcohol component for the esterification process with terephthalic acid, the terephthalate is solid at room temperature and cannot then be processed conventionally. If a mixture made of isononanol and 3,5,5-trimethylhexanol is used for producing the terephthalic esters (see Examples 1.6 and 1.7), the products obtained are solid or liquid at room temperature, and this varies with the average degree of branching. The hardening process here generally involves a delay, i.e. does not begin immediately after or during the cooling procedure but only after several hours or several days.

Esters which do not exhibit any melting signals when measured in DSC, and which exhibit a glass transition well below room temperature, are considered to have the best processability, since by way of example they can be stored in unheated outdoor tanks at any time of year anywhere in the world, and can be conveyed via pumps without difficulty. Esters which exhibit not only a glass transition but also one or more melting signals in the DSC thermogram, therefore exhibiting semicrystalline behaviour, cannot generally be processed under European winter conditions (i.e. at temperatures extending to −20° C.), because of premature solidification. According to the present results, the presence or absence of melting points depends primarily on the degree of branching of the ester groups. If the degree of branching is below 2.5 but above 1, the esters obtained have no melting signals in the DSC thermogram and exhibit ideal suitability for processing in expandable plastisols.

### Example 2

### Production of Expandable/Foamable PVC Plastisols (without Filler and/or Pigment)

The advantages of inventive plastisols will now be illustrated using a thermally expandable PVC plastisol that contains no filler and no pigment. The inventive plastisols hereinbelow are inter alia exemplary of thermally expandable plastisols used in the production of floor coverings. More particularly, the inventive plastisols hereinbelow are exemplary of foam layers used as back-side foams in PVC floorings of multilayered construction. The formulations presented are phrased in general terms, and can/have to be adapted by a person skilled in the art to the specific processing and service requirements applicable in the particular use sector.

TABLE 2
Composition of expandable PVC plastisols from Example 2
[all data in parts by mass]

| Plastisol recipe (Ex. 2) | 1** | 2* | 3* | 4* | 5** | 6** |
|---|---|---|---|---|---|---|
| Vinnolit MP 6852 | 100 | 100 | 100 | 100 | 100 | 100 |
| VESTINOL ® 9 | 50 | | | | | |
| dinonyl terephthalate as per | | 50 | | | | |
| Ex. 1.1 | | | | | | |
| dinonyl terephthalate as per | | | 50 | | | |
| Ex. 1.3 | | | | | | |
| dinonyl terephthalate as per | | | | 50 | | |
| Ex. 1.7 | | | | | | |
| dinonyl terephthalate as per | | | | | 50 | |
| Ex. 1.6 | | | | | | |
| VESTINOL ® INB | | | | | | 50 |
| Unifoam AZ Ultra 7043 | 3 | 3 | 3 | 3 | 3 | 3 |
| zinc oxide | 0.7 | 0.7 | 0.7 | 0.7 | 0.7 | 0.7 |

**= comparative example
*= according to invention

The materials and substances used are more particularly elucidated in what follows:

Vinnolit MP 6852: microsuspension PVC (homopolymer) with K-value (as per DIN EN ISO 1628-2) of 68; from Vinnolit GmbH & Co KG.
VESTINOL® 9: diisononyl orthophthalate (DINP), plasticizer; from Evonik Oxeno GmbH.
VESTINOL® INB: isononyl benzoate, plasticizer; from Evonik Oxeno GmbH.
Unifoam AZ Ultra 7043: azodicarbonamide; thermally activatable blowing agent; from Hebron S.A.
Zinc oxide: ZnO; decomposition catalyst for thermal blowing agent; lowers the inherent decomposition temperature of the blowing agent; also acts as stabilizer; “Zinkoxid Aktiv®”; from Lanxess AG. The zinc oxide was premixed with a sufficient amount (portion) of the particular plasticizer used and then added.

The liquid and solid constituents of a formulation were weighed separately into a suitable PE beaker in each case. The mixture was hand stirred with a paste spatula until all the powder had been wetted. The plastisols were mixed using a VDKV30-3 Kreiss dissolver (from Niemann). The mixing beaker was clamped into the clamping device of the dissolver stirrer. A mixer disc (toothed disc, finely toothed, Ø: 50 mm) was used to homogenize the sample. For this, the dissolver speed was raised continuously from 330 rpm to 2000 rpm, and stirring was continued until the temperature on the digital display of the temperature sensor reached 30.0° C. (temperature increase due to frictional energy/energy dissipation; see for example N. P. Cheremisinoff: “An Introduction to Polymer Rheology and Processing”; CRC Press; London; 1993). It was accordingly ensured that the plastisol was homogenized with defined energy input. Thereafter, the temperature of the plastisol was immediately brought to 25.0° C.

### Example 3

### Is Determination of Plastisol Viscosity after 24 h of Storage Time (at 25° C.) of Thermally Expandable Plastisols Produced in Example 2

The viscosities of the plastisols produced in Example 2 were measured using a Physica MCR 101 (Paar-Physica) rheometer, in accordance with the procedure described in Analysis, point 10 (see above). Table (3) below shows the results by way of example for shear rates 100/s, 10/s, 1/s and 0.1/s.

TABLE 3
Shear viscosity of plastisols from Example 2 after 24 h
of storage at 25° C.

| Plastisol recipe as per Ex. 2 | 1** | 2* | 3* | 4* | 5** | 6** |
|---|---|---|---|---|---|---|
| shear viscosity at | 6.11 | 6.48 | 9.64 | 10.15 | 22.2 | 1 |
| shear rate = 100/s [Pa * s] | | | | | | |
| shear viscosity at | 4.38 | 3.49 | 5.01 | 5.45 | 10.9 | 1.1 |
| shear rate = 10/s [Pa * s] | | | | | | |
| shear viscosity at | 4.95 | 3.37 | 4.3 | 4.55 | 8.23 | 2 |
| shear rate = 1/s [Pa * s] | | | | | | |
| shear viscosity at | 7.74 | 4.68 | 5.62 | 5.91 | 11.3 | 5.1 |
| shear rate = 0.1/s [Pa * s] | | | | | | |

**= comparative example
*= according to invention

The terephthalic esters used according to the invention result in PC plastisols which, compared with plastisols based on the present standard plasticizer DINP, have a distinctly lower paste viscosity in the region of low shear rates, while they are at the same level as the comparable DINP paste or slightly thereabove in the region of high shear rates. Compared with the isononyl benzoate-based plastisol (6), the PVC plastisols of the invention have a higher plastisol viscosity at high shear rates and the same or even lower viscosity values in the region of low shear rates. The dependency of plastisol viscosity on the degree of branching of the terephthalic esters used is very readily apparent. While the terephthalic esters used according to the invention, having a degree of ester group branching of up to 2.5, lead to plastisols having very good processing properties, plastisol (5), which was obtained on the basis of the more branched comparative example 1.6, shows a very much higher shear viscosity, and can for example no longer be readily processed using the common coating technologies (by blade coating for example). The INB plastisol has an extremely low viscosity, which is also distinctly below the viscosity of the DINP standard plastisol at high shear rates in particular. Thus, the terephthalic esters used according to the invention provide expandable plastisols which at high shear rates have a similar processability to the analogous DINP plastisols, but, owing to their lower plastisol viscosity at low shear rates, exhibit a distinctly more uniform flow in sprayed application for example.

### Example 4

### Determination of Gelling Behaviour of Thermally Expandable Plastisols Produced in Example 2

The gelling behaviour of the thermally expandable plastisols produced in Example 2 was tested as described under Analysis point 11. (see above) using a Physica MCR 101 in oscillation mode following plastisol storage at 25° C. for 24 h. The results are shown below in Table 4.

TABLE 4
Key points of gelling behaviour determined from gelling curves (viscosity
curves) of thermally expandable plastisols produced as per Example 2.

| Plastisol recipe (as per Ex. 2) | 1** | 2* | 3* | 4* | 5** | 6** |
|---|---|---|---|---|---|---|
| reaching a plastisol viscosity | 80 | 92.5 | 98 | 100 | 94 | 65 |
| of 1000 Pa * s at [° C.] | | | | | | |
| reaching a plastisol viscosity | 83.5 | 124 | 128 | 131 | 127.5 | 68 |
| of 10 000 Pa * s at [° C.] | | | | | | |
| maximum plastisol viscosity | 45000 | 21100 | 17800 | 17200 | 18900 | 85300 |
| [Pa * s] | | | | | | |
| temperature on reaching maximum | 116 | 139 | 142 | 141 | 142 | 82 |
| plastisol viscosity [° C.] | | | | | | |

**= comparative example
*= according to invention

The thermally expandable plastisols of the invention evidently have a disadvantage compared with the DINP plastisol (=standard plasticizer) in relation to gelling properties. They not only gel more slowly and/or at higher temperatures, they also reach scarcely half the final viscosity achieved via the comparable DINP plastisol (again at distinctly higher temperatures). According to established textbook opinion (e.g. F. Xing, C. B. Park in D. Klempner, V. Sendijarevic (ed.); “Polymeric Foams and Foam Technology”; Hanser; Munich; 2004; chapter 9.3.2.9) they should accordingly lead to foams of higher foam density, i.e. lower expansion. The INB plastisol, both compared with the DINP standard plastisol and compared with the terephthalate plastisols of the invention, exhibits very fast gelling (i.e. gelling at distinctly lower temperatures) and also has a maximum viscosity for this that is distinctly above the DINP standard.

### Example 5

### Production of Foam Foils and Determination of Expansion/Foaming Behaviour of Thermally Expandable Plastisols at 200° C. Produced in Example 2

Production of foam foils and determination of expansion/foaming behaviour were done in accordance with the procedure described under Analysis point 12. The average value of the thicknesses and the original thickness of 0.76 mm were used to compute the expansion. The results are shown below in Table 5.

TABLE 5
Expansion of polymer foams/foam foils obtained from thermally
expandable plastisols (as per Ex. 2) at different oven residence
times in Mathis Labcoater (at 200° C.).

| | Plastisol recipe (as per Ex. 2) | | | | | |
|---|---|---|---|---|---|---|
| | 1** | 2* | 3* | 4* | 5** | 6** |
| expansion after 60 s [%] | 42 | 35 | 62 | 49 | 22 | 8 |
| expansion after 90 s [%] | 400 | 386 | 393 | 385 | 420 | 326 |
| expansion after 120 s [%] | 481 | 508 | 495 | 522 | 528 | 420 |

**= comparative example
*= according to invention

Compared with the current standard plasticizer DINP, distinctly higher foam heights/expansion rates are achieved after a residence time of 120 seconds. The corresponding INB plastisol (plastisol recipe 6) reaches distinctly lower expansion values in all cases, both compared with the DINP standard sample and compared with the plastisols of the invention. Thermally expandable plastisols are thus provided which, despite evident disadvantages in gelling behaviour (see Example 4), have distinct advantages in thermal expandability, and thus permit faster processing and/or processing at lower processing temperatures.

The completeness of the decomposition of the blowing agent used and hence the progress of the expansion process is also evident from the colour of the foam produced. The lower the yellowness of the foam, the greater the degree to which the expansion process has advanced. The yellowness index of the polymer foams/foam foils produced in Example 5, as determined in accordance with Analysis point 13 (see above), is shown below in Table 6.

TABLE 6
Yᵢ D1925 yellowness indices of polymer foams produced in Example 5.

| | Plastisol recipe (as per Ex. 2) | | | | | |
|---|---|---|---|---|---|---|
| | 1** | 2* | 3* | 4* | 5** | 6** |
| yellowness index after 60 s | 57 | 59.5 | 58.5 | 58.8 | 61.8 | 67.9 |
| [%] | | | | | | |
| yellowness index after 90 s | 29 | 32.6 | 29.4 | 33.1 | 31.5 | 31.2 |
| [%] | | | | | | |
| yellowness index after 120 s | 21 | 20 | 21 | 19.3 | 18.5 | 18.1 |
| [%] | | | | | | |

**= comparative example
*= according to invention

True, the expandable plastisols which, in accordance with the invention, contain terephthalic esters are still distinctly higher in yellowness index after a residence time of 90 seconds in some instances than the comparable DINP foam, but after 120 seconds they do achieve a distinctly lower level in some instances. The INB plastisol starts from a distinctly higher level, is still higher than the DINP standard in the case of a 90 s residence time, and ends on a comparable level to the plastisols produced on the basis of the terephthalic esters used according to the invention. It is thus again found that the terephthalic esters used according to the invention, and the thermally expandable plastisols of the invention which are obtained therefrom, permit distinctly faster processing compared with the existing standard plasticizer DINP.

### Example 6

### Production of Expandable/Foamable PVC Plastisols (Using Filler and Pigment)

The advantages of inventive plastisols will now be illustrated using a thermally expandable PVC plastisol containing filler and pigment. The inventive plastisols hereinbelow are inter alia exemplary of thermally expandable plastisols used in the production of floor coverings. More particularly, the inventive plastisols hereinbelow are exemplary of foam layers used as printable and/or inhibitable top-side foams in PVC floorings of multilayered construction.

The plastisols were produced similarly to Example 2 except for a changed recipe. The component weights used for the various plastisols are discernible from the following Table (7):

TABLE 7
Composition of filled and pigmented expandable PVC plastisols
as per Example 6. [All data in parts by mass]

| | Plastisol recipe (Ex. 6) | | | | | |
|---|---|---|---|---|---|---|
| | 1** | 2* | 3* | 4* | 5** | 6** |
| Vinnolit MP 6852 | 60 | 60 | 60 | 60 | 60 | 60 |
| VESTINOL ® 9 | 45 | | | | | |
| dinonyl terephthalate as per | | 45 | | | | |
| Ex. 1.1 | | | | | | |
| dinonyl terephthalate as per | | | 45 | | | |
| Ex. 1.3 | | | | | | |
| dinonyl terephthalate as per | | | | 45 | | |
| Ex. 1.7 | | | | | | |
| dinonyl terephthalate as per | | | | | 45 | |
| Ex. 1.6 | | | | | | |
| isononyl benzoate | | | | | | 45 |
| Calibrite - OG | 60 | 60 | 60 | 60 | 60 | 60 |
| KRONOS 2220 | 4 | 4 | 4 | 4 | 4 | 4 |
| isopropanol | 2 | 2 | 2 | 2 | 2 | 2 |
| Unifoam AZ Ultra 7043 | 1.5 | 1.5 | 1.5 | 1.5 | 1.5 | 1.5 |
| zinc oxide | 0.85 | 0.85 | 0.85 | 0.85 | 0.85 | 0.85 |

**= comparative example
*= according to invention

The materials and substances used, unless already apparent from the preceding examples, are more particularly elucidated in what follows:

Calibrite-OG: calcium carbonate; filler; from OMYA AG.
KRONOS 2220: Al- and Si-stabilized rutile pigment (TiO₂); white pigment; from Kronos Worldwide Inc.
Isopropanol: cosolvent for lowering plastisol viscosity and also additive for improving foam structure (from Brenntag AG).

### Example 7

### Determination of Plastisol Viscosity of Filled and Pigmented Thermally Expandable Plastisols from Example 6 Following a Storage Period of 24 h (at 25° C.)

The viscosities of the plastisols produced in Example 6 were measured as described under Analysis point 10. (see above) using a Physica MCR 101 rheometer (from Paar-Physica). The results are shown in the following Table (8) for the shear rates 100/s, 10/s, 1/s and 0.1/s by way of example.

TABLE 8
Shear viscosity of plastisols from Example 6 after 24 h storage at 25° C.

| | Plastisol recipe as per Ex. 6 | | | | | |
|---|---|---|---|---|---|---|
| | 1** | 2* | 3* | 4* | 5** | 6** |
| shear viscosity at | 6.5 | 6.7 | 9 | 8.9 | n.db. | 1 |
| shear rate = 100/s [Pa * s] | | | | | | |
| shear viscosity at | 7 | 6.6 | 8.6 | 9.3 | n.db. | 1.3 |
| shear rate = 10/s [Pa * s] | | | | | | |
| shear viscosity at | 10.6 | 8.9 | 11.1 | 12.8 | 306 | 2.4 |
| shear rate = 1/s [Pa * s] | | | | | | |
| shear viscosity at | 21 | 16.4 | 20.2 | 24.4 | 529 | 6.9 |
| shear rate = 0.1/s [Pa * s] | | | | | | |

**= comparative example
*= according to the invention

The plastisol based on isononyl benzoate (INB) (comparative example; plastisol recipe 6) has the lowest shear viscosity at all reported shear rates. The plastisols of the invention, compared with the DINP used as standard plasticizer, have in some instances an appreciably lower shear viscosity, leading to distinctly improved processing properties, more particularly to an appreciably increased rate of application in spread and/or blade coating. The influence of branching on plastisol viscosity is distinctly apparent. The sample measured as sample 5 (comparative sample) with a degree of branching of 2.8 exhibits even at low shear rates a viscosity which is higher by an order of magnitude compared with the other samples, while at higher shear rates the measurement had to be discontinued on account of measurement tolerance being exceeded. This is accordingly evidence that plastisols of this type cannot be processed. By contrast, the invention provides plastisols which—depending on the degree of branching chosen—have similar processing properties to, or else distinctly improved processing properties than, plastisols based on the standard plasticizer DINP.

### Example 8

### Determination of Gelling Behaviour of Filled and Pigmented Thermally Expandable Plastisols from Example 6

The gelling behaviour of the filled and pigmented thermally expandable plastisols obtained in Example 6 was tested as described in Analysis point 11 (see above) using a Physica MCR 101 in oscillation mode following plastisol storage at 25° C. for 24 h. The results are shown below in Table (9).

TABLE 9
Key points of gelling behaviour determined from gelling curves (viscosity
curves) for filled and pigmented expandable plastisols obtained as per Example 6.

| | Plastisol recipe (as per Ex. 6) | | | | | |
|---|---|---|---|---|---|---|
| | 1** | 2* | 3* | 4* | 5** | 6** |
| reaching a plastisol | 82 | 113 | 117 | 118 | 118 | 67 |
| viscosity of 1000 Pa * s | | | | | | |
| at [° C.] | | | | | | |
| reaching a plastisol | 100 | 135 | 138 | 139 | 140 | 71 |
| viscosity of | | | | | | |
| 10 000 Pa * s at [° C.] | | | | | | |
| maximum plastisol | 31 300 | 16 400 | 14 900 | 13 900 | 13 700 | 45 200 |
| viscosity [Pa * s] | | | | | | |
| temperature on | 132 | 144 | 147 | 146 | 147 | 111 |
| reaching max. | | | | | | |
| plastisol viscosity [° C.] | | | | | | |

**= comparative example
*= according to invention

As with the unfilled thermally expandable plastisols (see Example 4; Table 4), the plastisol produced on the basis of isononyl benzoate (INB) gives the fastest gelling and/or the lowest gelling temperature for all plastisols reported. As is likewise apparent for the unfilled plastisols, the filled plastisols show an appreciable difference in gelling behaviour between the DINP plastisol (=standard) and the plastisols containing nonyl terephthalate. Gelling is slower with the terephthalic esters and only starts at distinctly higher temperatures. Moreover, the maximum plastisol viscosity attainable by gelling is only about half as high as with the DINP plastisol. Accordingly, it again had to be assumed that the foaming behaviour of plastisols containing nonyl terephthalate would be distinctly worse than that of the DINP plastisol.

### Example 9

### Production of Foam Foils and Determination of Expansion/Foaming Behaviour at 200° C. of thermally expandable plastisols obtained in Example 6

Production of foam foils and determination of expansion behaviour were done similarly to the procedure described under Analysis point 12 except that the filled and pigmented plastisols obtained in Example 6 were used. The results are shown in the following Table (10).

TABLE 10
Expansion of polymer foams/foam foils obtained from filled and
pigmented thermally expandable plastisols (as per Ex. 6) at
different oven residence times in Mathis Labcoater (at 200° C.).

| | Plastisol recipe (as per Ex. 6) | | | | | |
|---|---|---|---|---|---|---|
| | 1** | 2* | 3* | 4* | 5** | 6** |
| expansion after 60 s [%] | 0 | 0 | 5 | 0 | 20 | 8 |
| expansion after 90 s [%] | 230 | 190 | 250 | 192 | 300 | 224 |
| expansion after 120 s [%] | 285 | 300 | 315 | 300 | 360 | 184 |

**= comparative example
*= according to invention

As expected, the expansion with plastisols containing fillers is distinctly lower than those without fillers (see Example 5). However, as with the plastisols without filler, the plastisols containing the terephthalic esters used according to the invention again provide distinctly higher foam heights after a residence time of 120 seconds compared with the current standard plasticizer. The plastisol recipe (6) based on isononyl benzoate (INB), by contrast, only for up to a residence time of 90 seconds has an expansion which is at the level of the DINP standard (1), but below the value (3) obtainable with the pastes of the invention, and subsequently contracts again. The INB end sample (after 120 seconds) has a distinctly lower and completely unsatisfactory expansion compared both with the DINP standard and with the plastisols based on the terephthalic esters used according to the invention. The comparative sample (5) based on highly branched diisononyl terephthalate does possess very good foamability, but is unsuitable for industrial use because of its extremely disadvantageous rheological behaviour (see Table 8). Thermally expandable plastisols comprising fillers are thus provided which, despite evident disadvantages in gelling behaviour (see Example 8), have distinct advantages in thermal expandability.

Plastisols with fillers likewise make it possible (despite the presence of white pigment) to discern the completeness of the decomposition of the blowing agent azodicarbonamide used and hence the progress of the expansion process from the colour of the foam obtained. The lower the yellowness of the foam, the greater the degree to which the expansion process is finished.

The yellowness index of the polymer foams/foam foils obtained in Example 9, as determined in accordance with Analysis point 13 (see above), is shown in the following Table (11).

TABLE 11
Yᵢ D1925 yellowness indices of polymer foams obtained in Example 9.

| | Plastisol recipe (as per Ex. 6) | | | | | |
|---|---|---|---|---|---|---|
| | 1** | 2* | 3* | 4* | 5** | 6** |
| yellowness index after 60 s | 22.8 | 23.1 | 23.2 | 22.7 | 23.5 | 23.9 |
| [%] | | | | | | |
| yellowness index after 90 s | 19.5 | 20 | 19.2 | 19.2 | 18.2 | 17.6 |
| [%] | | | | | | |
| yellowness index after 120 s | 19.1 | 16.7 | 18.9 | 15.9 | 14.5 | 16.1 |
| [%] | | | | | | |

The plastisol obtained on the basis of isononyl benzoate (INB) starts with the highest yellowness index for all the plastisols measured, but drops to the level of the inventive plastisols after 120 seconds' residence time at 200° C. After just 90 seconds, the plastisols containing the terephthalic esters used according to the invention are at the level of the DINP plastisol. After 120 s, distinctly lower values are obtained than with DINP, i.e. the expansion process proceeds distinctly faster. Filled plastisols are thus provided which, despite evident disadvantages in gelling, permit a higher processing speed and/or lower processing temperatures.

### Example 10

### Production of Filled and Pigmented Expandable/Foamable PVC Plastisols for Effect Foams

The advantages of inventive plastisols will now be illustrated using filled and pigmented thermally expandable PVC plastisols useful for production of effect foams (foams with special surface texture). These foams are frequently also referred to as “bouclé” foams after the appearance pattern known from the textile sector. The inventive plastisols hereinbelow are inter alia exemplary of thermally expandable plastisols used in the production of wall coverings. More particularly, the inventive plastisols hereinbelow are exemplary of foam layers used in PVC wall coverings.

The plastisols were produced similarly to Example 2 except for a changed recipe. The component weights used for the various plastisols are discernible from Table 12 below.

TABLE 12
Composition of filled and pigmented expandable PVC plastisols
from Example 10 [all data in parts by mass].

| | Plastisol recipe | | | | | |
|---|---|---|---|---|---|---|
| | 1** | 2* | 3* | 4* | 5* | 6** |
| Vestolit E 7012 S | 25 | 25 | 25 | 25 | 25 | 25 |
| Vinnolit E 67 ST | 15 | 15 | 15 | 15 | 15 | 15 |
| Vinnolit EP 7060 | 10 | 10 | 10 | 10 | 10 | 10 |
| VESTINOL ® 9 | 25 | | | | | |
| dinonyl terephthalate as per | | 20 | | | | |
| Ex. 1.1 | | | | | | |
| dinonyl terephthalate as per | | | 20 | | | |
| Ex. 1.7 | | | | | | |
| dinonyl terephthalate as per | | | | 20 | | |
| Ex. 1.6 | | | | | | |
| dinonyl terephthalate as per | | | | | 20 | |
| Ex. 1.3 | | | | | | |
| Eastman DBT | | 5 | 5 | 5 | 5 | 25 |
| Unicell D200A | 2.25 | 2.25 | 2.25 | 2.25 | 2.25 | 2.25 |
| Tracel OBSH 160NER | 0.5 | 0.5 | 0.5 | 0.5 | 0.5 | 0.5 |
| Kronos 2220 | 1.5 | 1.5 | 1.5 | 1.5 | 1.5 | 1.5 |
| Microdol A1 | 15.5 | 15.5 | 15.5 | 15.5 | 15.5 | 15.5 |
| Baerostab KK 48-1 | 1.25 | 1.25 | 1.25 | 1.25 | 1.25 | 1.25 |
| isopropanol | 1.5 | 1.5 | 1.5 | 1.5 | 1.5 | 1.5 |

**= comparative example
*= according to invention

The materials and substances used are more particularly elucidated in what follows unless already apparent from the preceding examples:

Vestolit E 7012 S: emulsion PVC (homopolymer) with a K-value (determined as per DIN EN ISO 1628-2) of 67; from Vestolit GmbH.
Vinnolit E 67 ST: emulsion PVC (homopolymer) with a K-value (determined as per DIN EN ISO 1628-2) of 67; from Vinnolit GmbH & Co. KG.
Vinnolit EP 7060: emulsion PVC (homopolymer) with a K-value (determined as per DIN EN ISO 1628-2) of 70; from Vinnolit GmbH & Co. KG.
Eastman DBT: di-n-butyl terephthalate; plasticizer with fast gelling; from Eastman Chemical Co.
Unicell D200A: azodicarbonamide; thermally activatable blowing agent; from Tramaco GmbH.
Tracel OBSH 160NER: phlegmatized sulphonyl hydrazide (OBSH); thermally activatable blowing agent; from Tramaco GmbH.
Microdol A1: calcium magnesium carbonate (dolomite); filler; from Omya AG.
Baerostab KK 48-1: potassium/zinc kicker; decomposition catalyst for thermal blowing agents; lowers the inherent decomposition temperature of the blowing agent; also has a stabilizing effect; from Baerlocher GmbH.

### Example 11

### Determination of Plastisol Viscosity of Filled and Pigmented Thermally Expandable Plastisols from Example 10 Following a Storage Period of 24 h (at 25° C.)

The viscosities of the plastisols produced in Example 10 were measured as described under Analysis point 10. (see above) using a Physica MCR 101 rheometer (from Paar-Physica). The results are shown in the following Table (13) for the shear rates 100/s, 10/s, 1/s and 0.1/s by way of example.

TABLE 13
Shear viscosity of plastisols from Example 10 after 24 h storage at 25° C.

| | Plastisol recipe as per Ex. 10 | | | | | |
|---|---|---|---|---|---|---|
| | 1** | 2* | 3* | 4** | 5* | 6** |
| shear viscosity at | 9.15 | 7.2 | 8.15 | 14.5 | 8.15 | n.db. |
| shear rate = 100/s [Pa * s] | | | | | | |
| shear viscosity at | 10.7 | 6.75 | 7.1 | 12 | 7.5 | 49 |
| shear rate = 10/s [Pa * s] | | | | | | |
| shear viscosity at | 16.6 | 9.7 | 9.6 | 16.7 | 10 | 146 |
| shear rate = 1/s [Pa * s] | | | | | | |
| shear viscosity at | 34.8 | 20 | 18.2 | 33.9 | 19.4 | 655 |
| shear rate = 0.1/s [Pa * s] | | | | | | |

**= comparative example
*= according to the invention
n.db. = not determinable

The use of the fast-gelling dibutyl terephthalate (Eastman DBT) as sole plasticizer leads to plasticizers (presumably already pregelled at room temperature) of remarkably high viscosity, which are clearly not processable using the conventional technological processes. The plastisols of the invention, which contain diisononyl terephthalate mixtures together with small proportions of dibutyl terephthalate, have a viscosity which is distinctly lower compared with plastisol (1) based on DINP alone and which is also distinctly lower than that of the non-inventive higher-branched isononyl terephthalate mixture (4). The invention thus provides plastisols which permit distinctly faster processing compared with the known standard (DINP).

### Example 12

### Determination of Gelling Behaviour of Filled and Pigmented Thermally Expandable Plastisols from Example 10

The gelling behaviour of the filled and pigmented thermally expandable plastisols obtained in Example 10 was tested as described in Analysis point 11 (see above) using a Physica MCR 101 in oscillation mode following plastisol storage at 25° C. for 24 h. The results are shown below in Table (14).

TABLE 14
Key points of gelling behaviour determined from gelling curves
(viscosity curves) for filled and pigmented expandable plastisols
obtained as per Example 10.

| | Plastisol recipe (as per Ex. 10) | | | | | |
|---|---|---|---|---|---|---|
| | 1** | 2* | 3* | 4** | 5* | 6** |
| reaching a | 74 | 76 | 79 | 79 | 79 | 54 |
| plastisol | | | | | | |
| viscosity of | | | | | | |
| 1000 Pa * s | | | | | | |
| at [° C.] | | | | | | |
| reaching a | 84 | 96 | 100 | 101 | 101 | 61 |
| plastisol | | | | | | |
| viscosity of | | | | | | |
| 10 000 Pa * s | | | | | | |
| at [° C.] | | | | | | |
| maximum | 25200 | 21000 | 20000 | 20700 | 19900 | 98500 |
| plastisol | | | | | | |
| viscosity | | | | | | |
| [Pa * s] | | | | | | |
| temperature on | 117 | 125 | 127 | 127 | 127 | 78 |
| reaching max. | | | | | | |
| plastisol | | | | | | |
| viscosity | | | | | | |
| [° C.] | | | | | | |

**= comparative example
*= according to invention

The special position of the dibutyl terephthalate-based plastisol is also distinctly apparent in the gelling curve. The plastisol in question already starts at room temperature on a distinctly higher level (about factor 2) than all the other plastisols considered, which is indicative of pregelling even at room temperature and inadequate processability. With regard to initial gelling temperature, the plastisols of the invention are at the same level as the standard plastisol (DINP) as at the maximum end viscosity attainable, merely the speed at which the maximum plastisol viscosity is reached starting from the initial gelling temperature is somewhat slower with the plastisols of the invention than that of the DINP plastisol. Plastisols for producing effect foams are thus provided which—coupled with improved processing properties (see Example 11)—have essentially similar gelling properties to the current standard system and at the same time are free of ortho-phthalates.

### Example 13

### Production and Assessment of Effect Foam from Filled and Pigmented Thermally Expandable Plastisols as Per Example 10

The plastisols obtained in Example 10 were aged about two hours and foamed up in a Mathis Labcoater (type LTE-TS; manufacturer: W. Mathis AG). The support used was a coated wall covering grade paper (from Ahlstrom GmbH). The blade coating unit was used to apply the plastisols in 3 different thicknesses (300 μm, 200 μm and 100 μm). In each case 3 plastisols were applied to the paper side by side. The precoated paper thus obtained was foamed and gelled in the Mathis oven at 210° C. for 60 seconds.

The yellowness indices were determined on the fully gelled samples as described under Analysis point 13 (see above).

In the assessment of expansion behaviour the DINP sample is used as comparative standard. A normal expansion behaviour (=OK) thus corresponds to the behaviour of the DINP sample. In the case of what is called “overfoaming” there is a collapse of the foam structure, i.e. expansion behaviour is poor in that case.

In the assessment of surface quality/surface texture it is particularly the uniformity or regularity of the surface textures which is assessed. The dimensional extent of the individual constituents of the effect likewise enters the assessment.

Another appraisal is the appraisal of reverse side (paper) with regard to any exudation/migration of recipe constituents. The rating system underlying the surface texture assessment is shown in the following Table (15).

TABLE 15
Assessment system for judging surface quality of effect foams

| Assess- | |
|---|---|
| ment | Meaning |
| 1 | Very good surface texture (very high regularity and |
| | uniformity of surface effects; size of individual |
| | effects exactly in keeping). |
| 2 | Good surface texture (high regularity and uniformity |
| | of surface effects; size of individual effects |
| | exactly in keeping). |
| 3 | Satisfactory surface texture (regularity and |
| | uniformity of surface effects acceptable; size of |
| | individual effects appropriate). |
| 4 | Adequate surface texture (slight irregularities or |
| | non-uniformities in surface texture; size of |
| | individual effects slightly unbalanced). |
| 5 | Defective surface texture (irregularities and |
| | non-uniformities in surface texture; size of |
| | individual effects unbalanced). |
| 6 | Inadequate surface texture (highly irregular and |
| | non-uniform surface effects; size of individual |
| | effects not at all in keeping (much too large/much |
| | too small)). |

The rating system underlying the assessment of the reverse-side appraisal (migration) is depicted in the following Table (16).

TABLE 16
Assessment system for reverse-side appraisal of effect foams.

| Assess- | |
|---|---|
| ment | Meaning |
| 1 | Very good (no evident diffusion/migration; no colour |
| | difference in edge region). |
| 2 | Good (no evident diffusion/migration; minimal colour |
| | difference in edge region). |
| 3 | Satisfactory (minimal diffusion/migration; slight |
| | colour difference in application region). |
| 4 | Adequate (slight diffusion/migration; distinct colour |
| | difference in application region) |
| 5 | Defective (distinct signs of migration; slightly |
| | “greasy” haptics; marked colour difference in |
| | entire application region). |
| 6 | Inadequate (marked signs of migration; marked |
| | “greasy” haptics; extreme colour difference |
| | in entire application region). |

The surface texture of an effect foam (i.e. of a foam which is supposed to exhibit special/specially pronounced surface texturing) is determined essentially by the constituents and the processing properties of the plastisol used for producing it. Of particular importance here are the plastisol viscosity, the flow behaviour of the plastisol (characterized for example by the course of plastisol viscosity as a function of shear rate), the gelling behaviour of the plastisol (pivotal for the size and distribution of gas bubbles inter alia), the influence of the plasticizers used on the decomposition of the blowing agent (what is known as auto kick effects), and also the choice and combination of blowing agent(s) and decomposition catalyst(s). These are essentially influenced by the choice of materials used and are controllable in a specific manner in this way.

Appraising the reverse side of coated paper allows inferences to be drawn about the permanence in the fully gelled system of the plasticizers used and of other formulation constituents. Pronounced migration of formulation constituents has numerous practical disadvantages as well as optical and aesthetic disadvantages. Increased tackiness attracts dust, which is difficult to remove again, if it can be removed at all, and thus very quickly leads to a negative appearance. In addition, migration of formulation constituents generally has very adverse repercussions for printability/durability of a print. Furthermore, interactions with securing adhesives (wallpaper adhesives for example) can lead to uncontrolled detachment of a wall covering.

The results of surface and reverse-side appraisal are summarized in Table 17.

TABLE 17
Results of surface and reverse-side appraisal of
fully gelled effect foams from Example 13.

| | Plastisol recipe (as per Ex. 10) | | | | | |
|---|---|---|---|---|---|---|
| | 1** | 2* | 3* | 4** | 5* | 6** |
| expansion behaviour | — | O.K. | O.K. | O.K. | O.K. | overfoamed |
| yellowness index | 7.3 | 6.6 | 6.7 | 6.5 | 6.8 | 6.3 |
| assessment of | 2 | 1 | 1 | 1 | 1 | 6 |
| surface quality/texture | | | | | | |
| assessment of reverse | 1 | 1 | 1 | 1 | 1 | 1 |
| side after 24 h | | | | | | |
| assessment of reverse | 1 | 2 | 2 | 1 | 2 | 1 |
| side after 7 days | | | | | | |

**= comparative example
*= according to invention

All samples except that containing only dibutyl terephthalate (DBT) as plasticizer are good in terms of expansion behaviour, equivalent to the DINP standard. The DBT is very prone to overfoaming, i.e. has poor expansion behaviour. The yellowness index shows that the plastisols of the invention reach distinctly lower values compared with the DINP standard, meaning that expansion is distinctly faster here. The surface texture assessment shows the result of the expansion behaviour for the DBT plastisol. The overfoaming leads to the formation of an inadequate surface texture and/or to premature collapse thereof. All plastisols according to the invention, by contrast, exhibit a very good surface texture which, surprisingly, even shows distinct improvements over the DINP standard. With regard to obvious (i.e. visually discernible) phenomena of migration, none of the samples shows any evidence of migration after 24 h storage (at 25° C.). Even after 7 days' storage (at 25° C.) none of the effect foams according to the invention shows any migration phenomena whatsoever. The invention thus provides plastisols and effect foams obtainable therefrom that are superior or at least equivalent to the known prior art in visual respects while having significant advantages with regard to processability.

### Example 14

### Production of Filled and Pigmented Expandable/Foamable PVC Plastisols for Smooth Foams

The advantages of inventive plastisols will now be illustrated using filled and pigmented thermally expandable PVC plastisols useful for producing so-called smooth foams (foams having a smooth surface). The inventive plastisols hereinbelow are inter alia exemplary of thermally expandable plastisols used in the production of wall coverings. More particularly, the inventive plastisols hereinbelow are exemplary of foam layers used in PVC wall coverings.

The plastisols were produced similarly to Example 2 except for a changed recipe. The component weights used for the various plastisols are discernible from the following Table (18).

TABLE 18
Composition of filled and pigmented expandable PVC
plastisols from Example 14 [all data in parts by mass].

| | Plastisol recipe | | | | | |
|---|---|---|---|---|---|---|
| | 1** | 2* | 3* | 4** | 5* | 6** |
| Vestolit E 7012 S | 20 | 20 | 20 | 20 | 20 | 20 |
| Vinnolit E 67 ST | 17.5 | 17.5 | 17.5 | 17.5 | 17.5 | 17.5 |
| Vestolit B 6021 Ultra | 12.5 | 12.5 | 12.5 | 12.5 | 12.5 | 12.5 |
| VESTINOL ® 9 | 30 | | | | | |
| dinonyl terephthalate as per | | 25 | | | | |
| Ex. 1.1 | | | | | | |
| dinonyl terephthalate as per | | | 25 | | | |
| Ex. 1.7 | | | | | | |
| dinonyl terephthalate as per | | | | 25 | | |
| Ex. 1.6 | | | | | | |
| dinonyl terephthalate as per | | | | | 25 | |
| Ex. 1.3 | | | | | | |
| Eastman DBT | | 5 | 5 | 5 | 5 | 30 |
| Unicell D200A | 1.8 | 1.8 | 1.8 | 1.8 | 1.8 | 1.8 |
| Drapex 39 | 2.4 | 2.4 | 2.4 | 2.4 | 2.4 | 2.4 |
| Kronos 2220 | 2.4 | 2.4 | 2.4 | 2.4 | 2.4 | 2.4 |
| Microdol 1 | 24 | 24 | 24 | 24 | 24 | 24 |
| Baerostab KK 48-1 | 1 | 1 | 1 | 1 | 1 | 1 |

**= comparative example
*= according to invention

The materials and substances used are more particularly elucidated in what follows unless already apparent from the preceding examples:

Vestolit B 6021 Ultra: microsuspension PVC (homopolymer) having a K-value (determined as per DIN EN ISO 1628-2) of 60; from Vestolit GmbH.
Drapex 39: epoxidized soybean oil; (co)stabilizer with plasticizing effect; from Chemtura/Galata.

### Example 15

### Determination of Plastisol Viscosity of Filled and Pigmented Thermally Expandable Plastisols from Example 14 Following a Storage Period of 24 h (at 25° C.)

The viscosities of the plastisols produced in Example 14 were measured as described under Analysis point 10. (see above) using a Physica MCR 101 rheometer (from Paar-Physica). The results are shown in the following Table (19) for the shear rates 100/s, 10/s, 1/s and 0.1/s by way of example.

TABLE 19
Shear viscosity of plastisols from Example 14 after 24 h storage at 25° C.

| | Plastisol recipe as per Ex. 14 | | | | | |
|---|---|---|---|---|---|---|
| | 1** | 2* | 3* | 4** | 5* | 6** |
| shear viscosity at | 8.2 | 6.9 | 8.2 | n.db. | 8.3 | 10.9 |
| shear rate = 100/s [Pa * s] | | | | | | |
| shear viscosity at | 7.4 | 5.4 | 7 | 23.7 | 6.95 | 16.2 |
| shear rate = 10/s [Pa * s] | | | | | | |
| shear viscosity at | 8.4 | 5.8 | 7.2 | 23.7 | 6.8 | 29 |
| shear rate = 1/s [Pa * s] | | | | | | |
| shear viscosity at | 13 | 8.9 | 11.2 | 35.2 | 10.2 | 75 |
| shear rate = 0.1/s [Pa * s] | | | | | | |

**= comparative example
*= according to the invention
n.db. = not determinable

All examples according to the invention exhibit a distinctly lower plastisol viscosity not only compared with purely DINP (=standard) but also in comparison with purely dibutyl terephthalate. The more highly branched comparative example (4) likewise has a distinctly higher plastisol viscosity and is neither measurable nor processable at high shear rates of the type occurring in processing by blade coating or spraying for example. Plastisols are thus provided which permit distinctly better and faster processing compared with the current standard.

### Example 16

### Determination of Gelling Behaviour of Filled and Pigmented Thermally Expandable Plastisols from Example 14

The gelling behaviour of the filled and pigmented thermally expandable plastisols obtained in Example 14 was tested as described in Analysis point 11. (see above) using a Physica MCR 101 in oscillation mode following plastisol storage at 25° C. for 24 h. The results are shown below in Table (20).

TABLE 20
Key points of gelling behaviour determined from gelling curves
(viscosity curves) for filled and pigmented expandable plastisols
obtained as per Example 14.

| | Plastisol recipe (as per Ex. 14) | | | | | |
|---|---|---|---|---|---|---|
| | 1** | 2* | 3* | 4** | 5* | 6** |
| reaching a | 81 | 89 | 93 | 94 | 93 | 62 |
| plastisol | | | | | | |
| viscosity of | | | | | | |
| 1000 Pa * s | | | | | | |
| at [° C.] | | | | | | |
| reaching a | 98 | 120 | 123 | 123 | 122 | 66 |
| plastisol | | | | | | |
| viscosity of | | | | | | |
| 10 000 Pa * s | | | | | | |
| at [° C.] | | | | | | |
| maximum | 22700 | 16000 | 14100 | 14200 | 14700 | 73700 |
| plastisol | | | | | | |
| viscosity | | | | | | |
| [Pa * s] | | | | | | |
| temperature on | 125 | 132 | 132 | 132 | 134 | 80 |
| reaching max. | | | | | | |
| plastisol | | | | | | |
| viscosity | | | | | | |
| [° C.] | | | | | | |

**= comparative example
*= according to invention

The plastisol based only on dibutyl terephthalate shows—as was already the case with the effect foam recipe (see Ex. 12)—distinct signs of pregelling at room temperature. Accordingly, despite rapid gelling at low temperatures, there is no processability using conventional technologies. The plastisols of the invention show a somewhat slower gelling at slightly increased gelling temperatures, but maximum paste viscosity in the gelled state is reached at a similar temperature as with DINP standard plastisol. Plastisols are thus provided which—coupled with significantly improved processing properties (see Example 15)—have essentially similar gelling properties to the current standard system and are simultaneously free of ortho-phthalates.

### Example 17

### Production and Appraisal of Smooth Foam from Thermally Expandable Plastisols as Per Example 14

The smooth foams were produced similarly to the procedure described in Example 13 except that the plastisols produced in Example 14 were used. Expansion behaviour was assessed similarly to the procedure described in Example 13. Yellowness indices were determined on the fully gelled samples as described under Analysis point 13 (see above). When it comes to appraising the surface quality/surface texture of smooth foams it is particularly the uniformity and/or smoothness of the surface texture which is assessed. In addition, the reverse side (paper) is appraised with regard to any exudation/migration of recipe constituents. The assessment system is shown in the following Table (21).

TABLE 21
Assessment system for surface quality of smooth foams.

| Assess- | |
|---|---|
| ment | Meaning |
| 1 | Very good surface texture (very high uniformity & |
| | smoothness; no irregularities) |
| 2 | Good surface texture (high uniformity & smoothness; |
| | minimal irregularities) |
| 3 | Satisfactory surface texture (uniformity & smoothness |
| | acceptable and few irregularities) |
| 4 | Adequate surface texture (slight nonuniformities in |
| | surface texture & reduced smoothness; distinct but |
| | homogeneously distributed irregularities) |
| 5 | Defective surface texture (distinct nonuniformities |
| | in surface texture & distinctly reduced smoothness; |
| | distinct irregularities discernible) |
| 6 | Inadequate surface texture (markedly nonuniform surface |
| | texture, distinctly rough and/or granular and/or |
| | undulating surface, markedly inhomogeneous distribution |
| | of irregularities) |

The reverse sides were assessed similarly to the assessments in relation to effect foams (see Example 13/Table 16).

The surface texture of a smooth foam (i.e. of a foam which is supposed to have a smooth surface texturing) is, as was the case with effect foam, essentially determined by the processing properties of the plastisol used for producing it. Of particular importance again are the plastisol viscosity, the flow behaviour of the plastisol (characterized for example by the course of plastisol viscosity as a function of shear rate), the gelling behaviour of the plastisol (pivotal for the size and distribution of gas bubbles inter alia), the rate of gas bubble coalescence and the influence of the plasticizers used on the decomposition of the blowing agent (what is known as auto kick effects), and also the choice and combination of blowing agent(s) and decomposition catalyst(s). The specific use of surface-active substances (such as dispersing and/or wetting agents for example) can also be used to control the open or closed cell content of the foam. The choice of starting materials thus has an essential effect on the end result in this case also.

Appraising the reverse side of coated paper allows inferences to be drawn again about the permanence in the fully gelled system of the plasticizers used and of other formulation constituents. Pronounced migration of formulation constituents has numerous disadvantages, as already discussed, and is generally a knock-out criterion for the use of the corresponding recipe.

The results of the surface appraisal are summarized in the following Table (22).

TABLE 22
Results of surface and reverse-side appraisal of
fully gelled effect foams from Example 14.

| | Plastisol recipe (as per Ex. 14) | | | | | |
|---|---|---|---|---|---|---|
| | 1** | 2* | 3* | 4** | 5* | 6** |
| expansion behaviour | — | O.K. | O.K. | O.K. | O.K. | O.K. |
| yellowness index | 8.8 | 8.2 | 8.5 | 8.4 | 8.4 | 8.7 |
| assessment of | 2 | 2 | 2.5 | 2.5 | 2 | 2 |
| surface quality/texture | | | | | | |
| assessment of reverse side | 1 | 1 | 1 | 1 | 1 | 1 |
| after 24 h | | | | | | |
| assessment of reverse side | 1 | 2 | 2 | 2 | 2 | 1 |
| after 7 days | | | | | | |

All examples according to the invention exhibit an expansion behaviour which is comparable to the DINP standard and also a yellowness index which is consistently below the value of the DINP standard. Similarly, the surface quality of the smooth foams produced is equivalent to that of the DINP standard smooth foam, and similarly no migration into the wall covering paper is observed whatsoever. Plastisols and foams are thus provided which have distinctly improved properties compared with the known prior art.

1. A foamable composition, comprising:
a polymer;
a foam former, a foam stabilizer, or a combination thereof; and
diisononyl terephthalate as a plasticizer,
wherein the polymer is at least one polymer selected from the group consisting of polyvinyl chloride, polyvinyl butyrate, polyhydroxyalkanoate, polyalkyl methacrylate, polyvinylidene chloride, and a copolymer thereof, and an average degree of branching of an isononyl group in a diisononyl terephthalate ester is from 1.15 to 2.5.

2. The foamable composition according to claim 1, wherein the polymer is polyvinyl chloride.

3. The foamable composition according to claim 1, wherein the polymer is a copolymer of vinyl chloride having at least one monomer selected from the group consisting of vinylidene chloride, vinyl acetate, vinyl propionate, vinyl butyrate, vinyl benzoate, methyl acrylate, ethyl acrylate, and butyl acrylate.

4. The foamable composition according to claim 1, wherein the foamable composition comprises the diisononyl terephthalate in an amount of from 5 to 120 parts by mass per 100 parts by mass of the polymer.

5. The foamable composition according to claim 1, further comprising:
an additional plasticizer,
wherein the additional plasticizer is not diisononyl terephthalate.

6. The foamable composition according to claim 1,
wherein the foam former is a gas bubble evolver.

7. The foamable composition according to claim 1, further comprising:
a PVC microsuspension, a PVC emulsion, or a combination thereof.

8. The foamable composition according to claim 1, further comprising:
a constituent selected from the group consisting of a filler, a pigment, a matting agent, a thermal stabilizer, a thermal costabilizer, an antioxidant, a viscosity regulator, a foam stabilizer, a processing aid, and a lubricant.

9. A method for producing a floor covering, a wall covering or artificial leather, the method comprising:
applying the foamable composition according to claim 1.

10. A foamed moulding comprising:
the foamable composition according to claim 1.

11. A floor covering containing comprising:
a foamed state of the foamable composition according to claim 1.

12. A wall covering comprising:
a foamed state of the foamable composition according to claim 1.

13. An artificial leather comprising:
a foamed state of the foamable composition according to claim 1.

14. The foamable composition according to claim 6, further comprises:
a kicker.
